(19) United States
(12) Patent Application Publication
(10) Pub. No.: US 2010/0212436 A1
(43) Pub. Date: Aug. 26, 2010

(54) Single use sterile slit impact sampling cassette with rotatable capture tray

(76) Inventors: Erik Axel Swenson, Longmont, CO (US); Donald Jason Dennis, Frederick, CO (US)

Correspondence Address: Erik Swenson, 2232 Blue Bird Dr., Longmont, CO, 80504, US

(21) Appl. No.: 12/660,495

(22) Filed: Feb. 25, 2010

Related U.S. Application Data
(60) Provisional application No. 61/202,395, filed on Feb. 25, 2009.

(51) Int. Cl. G01N 1/14

(52) U.S. Cl. 73/863.22

(57) ABSTRACT

A single use sterile slit impact sampling cassette with rotatable capture tray for recovering particulate matter from ambient air, having a lid with a slit shaped air inlet, dish with an air outlet, and capture tray. The dish and lid assemble to form a sealed sample chamber, which houses the capture tray. The assembled cassette is sterile packaged with its inlet and outlet covered before use. The cassette is placed on a base for operation, which supplies the required vacuum for sampling, and rotational means for the capture tray. Air drawn into the air inlet is accelerated to a velocity that ensures impingement, or entrainment of particulate matter from the sampled air volume onto, or within the capture media. The sampled air volume is evacuated from the sample chamber through an air outlet. The cassette is then removed from the operative base, and then may be analyzed for the target contaminants.

### CROSS-REFERENCE TO RELATED APPLICATIONS

This application claims the benefit of the filing date of U.S. Provisional Patent Application No. 61/202,395, filed Feb. 25, 2009, Titled: Single Use Air Impact Sampling Cassette with Rotatable Capture Tray.

### STATEMENT REGARDING FEDERALLY SPONSORED RESEARCH OR DEVELOPMENT

-Not Applicable-

### REFERENCE TO SEQUENCE LISTING, A TABLE, OR A COMPUTER PROGRAM LISTING COMPACT DISK APPENDIX

-Not Applicable-

### BACKGROUND OF THE INVENTION

1. Field of the Invention

The present invention relates in general to an apparatus for the recovery and measurement of airborne contamination. In particular, the present invention relates to an improved slit impact sampling device for use in critical environments such as pharmaceutical, biotech, or medical clean rooms, which will allow for the impaction of air and entrained particulates upon a capture media located on a rotatable tray within a sealed cassette assembly, removeably attached to a base assembly for operation. The rotatable tray, capture media and cassette with integral air inlet and outlet are designed and manufactured in a manner to ensure the sterile integrity of the device up to the time of sampling. Therefore, substantially removing the risk of obtaining “false positive” results from the use or set up of the device, such that the capture media may then be analyzed to determine the presence of a variety of viable and non-viable particles within the environment tested with the confidence that those results obtained come from that environment.

2. Description of the Prior Art

A number of different types of devices have been developed to measure contamination of ambient air in controlled environments such as ISO 5 through ISO 9 clean rooms found in pharmaceutical, biotechnology, research and medical facilities. Some of the more common types of these devices include microbiological air samplers which employ a variety of means in which to impact particulate matter, contained within the sampled volume of air, and thus any viable microorganisms associated with it onto, or into a variety of test mediums. Following testing with these methods, the quantity and/or types of viable microorganisms in air borne particles can then be determined by standard bacteriological methods. For example, where the viable particles are deposited on an agar surface, the microbial colonies can be incubated on the medium and can be counted and identified under a microscope or by using a variety of microbial identification technologies.

The most successful types of microbiological air samplers have been the slit-to-agar (STA) or slit impact microbiological air samplers. The slit impact sampler has received wide recognition in the field of medicine, research and industry for the analysis of contamination levels of ambient air environments and has been in regular use to determine air quality in a variety of controlled environments for decades. Several models of slit impact samplers have been developed and described over the years. These samplers include, but are not limited to the Fort Detrick Slit Sampler (described in Sampling Microbiological Aerosols, Public Health Monograph No. 60, at 36); the Slit-to-Agar (STA) Air Sampler from Barramundi Corporation of Homosassa, Fla.; the STA 203 and 204 Samplers from New Brunswick Scientific; Casella Slit Sampler (described in Public Health Monograph, No. 60, at 38), the Air Trace® Environmental Slit-to-Agar sampler from Baker, Biap Slit-to-Agar Air Sampler marketed by Scantago APS of Denmark, and R2S STA Air Sampler, per U.S. Pat. No. 5,831,182, manufactured and marketed by EMETK, LLC,.

The slit impact sampler utilizes a test plate rotating on a platform under a slit-type orifice in a substantially sealed sample chamber. The air sample is drawn into the sample chamber through a slit-type orifice, by means of an directly attached or remotely supplied vacuum source, and impinges the air sample directly upon the test plate containing a nutrient collection medium of solidified agar rotating on the platform beneath the slit-type orifice. Air passing through the slit-type orifice is accelerated to a velocity that insures impingement of particulate matter from the sampled air volume onto the test media. Viable particles immediately find nutrients suitable for their growth in the collection medium, and the sampled air volume then leaves the sample chamber through an opening in the base or sidewall of the sample chamber. Incubation of the nutrient collection plate following testing permits the growth of colonies from the initial organism(s) captured on the plate, which are initially invisible to the naked eye. After an appropriate time period (e.g., 48-72 hours) at an appropriate incubation temperature (e.g., 30-35° C.) the microorganisms replicate and the colonies become large enough to be visually counted and analyzed.

Analysis generally includes performing a total count of microbial colonies recovered, determination of the contamination level per volume of air in the environment, and microbial identification of the microorganisms recovered. Additionally, rotation of the test plate on a rotating platform within the sealed sample chamber, under the slit-type orifice, by means such as an electric motor as described in U.S. Pat. No. 5,831,182, or clock mechanism as described in U.S. Pat. No. 3,972,226, has several crucial functions. Rotation of the test plate assures uniform particle distribution over the surface of the collecting medium, allows for lengthy sample periods which may exceed 60-minutes with some devices, allows for more accurate enumeration of microorganisms recovered as they are not as readily impacted atop one another, removes the recovered microorganisms from the direct influx of sampled air thus minimizing loss of microorganisms captured due to desiccation, and allows for determination of the time of microbial recovery which can then be linked with operations that occurred during that time period, aiding in contamination investigation and product impact assessment. These are key advantages of slit impact sampling devices over air sampling devices that have fixed capture medias.

The prior art in slit impact samplers have been designed extremely well for microbial recovery purposes, and have been the standard to which other air viable samplers have been compared due to their excellent recovery capabilities. Industry guidance limits for microbial contamination levels of the air in clean room environments have been based on that of the recovery of slit impact air sampling devices for this reason. But, the majority of these devices have not been designed appropriately for use in controlled environments, and several serious deficiencies with most of these samplers has existed and still exists today.

As described substantially in U.S. Pat. No. 5,831,182, the physical presence and operation of microbial air samplers can impart a very negative impact on controlled environments in which they are utilized. With the exception of the remote slit impact sampler described in U.S. Pat. No. 5,831,182, the physical presence and operation of other slit impact samplers can cause a great deal of turbulence within the laminar airflow of controlled environments. This due to the disruption in laminar airflow caused by the substantial size and shape of the samplers and also due to disruption caused by discharge of the sampled air volume from the devices within the test environment. Turbulence caused by the exhaust or physical equipment can introduce air and associated contaminants from downstream, back into the critical area of a controlled environment, where it may jeopardize processing, products, patients, or test materials. The devices themselves may also harbor substantial contaminants picked up from handling and use inside and outside of the controlled environments in which they may be used, which may then be shed within the critical environments in which they are used for testing. Complete sanitization and/or sterilization of the units to remove contaminants can be time consuming and may not be possible to obtain for these devices.

Inventor Swenson overcame the significant deficiencies with larger slit impact samplers with the invention of the remote slit impact air sampler described in U.S. Pat. No. 5,831,182. This device, marketed as the R2S Air Sampler, manufactured by EMTEK, LLC, has been found to be significantly more ideal for use in clean room environments since its production release in 1998. This small slit impact air sampling device reduces the cost of testing by utilizing standard 100 mm (or 90 mm) test plates instead of 150 mm (or 140 mm) test plates and significantly minimizes the impact of air testing equipment in the controlled environments and operations due to its small stature, its sealed componentry, construction from both sanitizable and sterilizable non shedding materials, and its remote operation from the controller, moving the control system, vacuum source and the exhaust of the sample volume outside of the critical environment.

Although Swenson's remote slit sampler described in U.S. Pat. No. 5,831,182 substantially lowers the contamination risk and cost associated of operating an air sampler in a critical environment, complete sanitization and/or sterilization of the unit cannot be guaranteed. The dome and air inlet assembly, as well as the dome-to-base seal of the R2S Air Sampler may be autoclaved to obtain sterility, but this in itself can be a time and cost burden, and complete sterilization of the interior of the test chamber components, that lie beneath the inlet dome, cannot be guaranteed. Additionally, the manipulation required to place and remove the test media on the turntable within the sample chamber can allow for the deposition of contaminants on the test media. As such, viable and non-viable particulate matter, which may be accumulated within the sampling chamber during handling and transport inside and outside of a controlled environment, or during set up for testing may be picked up as false positive events when testing with the device is performed. These false positive events may then put into question processing, products, surgeries or other aseptic manipulations performed in that environment when the testing was performed.

The air sampling cassette as defined in U.S. Pat. No. 6,472,203, which combines an air sampling cassette and fixed nutrient media dish for the collection of airborne particles, overcomes the concern described previously by ensuring a sterile sampling device and test media is initially employed for testing. The small sampling device as described in U.S. Pat. No. 6,472,203, and as marketed today, comes sterile packaged with a protective cover over the inlet orifice plate and air outlet that are removed before use and replaced after use to maintain the sterility of the medium dish within the cassette free from contaminants. The inclusion of the medium within the sterile cassette also greatly reduces the risk of false positives as the test plate containing the nutrient media does not have to be manipulated to place it on the device for sampling and then removed after testing, greatly minimizing the risk of test plate contamination. This “sieve” style air sampler, based generally on the sixth stage of the Anderson Air sampler described in U.S. Pat. No. 3,001,914, functions as other all types of sieve air samplers whereas the air is drawn in through a plurality of inlet holes, spaced evenly across the top lid surface, onto a fixed media surface contained within a substantially sealed chamber of the device by applying a vacuum source to the air outlet on the side or bottom of the device.

Although this device overcomes many of the burdens of operation related to set up and sanitization/sterilization, equipment cost, and ease of use when compared to other sieve samplers on the market, such as the Anderson Air Sampler (U.S. Pat. No. 3,001,914, SMA Air Sampler from Veltek Associates, Inc., MAS-100® from Merck, SAS from Bioscience International, MairT from Millipore Corporation, etc., it does not offer the benefits of a slit impact sampler previously described. This sampling cassette and nutrient dish combination, as it is described in its preferred design in U.S. Pat. No. 6,472,203, and as it available in the industry today, is not designed or intended to lend itself to the inclusion of a rotating capture platform, as it only describes and includes a fixed media dish and its orifice plate includes an inlet pattern of 200-400 holes of 0.0100″ to 0.0465″ spaced evenly across that plate surface and as such would not benefit from the employment of a rotating capture media below.

It is desirable in many instances to have extended monitoring capabilities at lower sampling rates to perform testing during lengthy production operations, such as that offered by the air sampling cassette of U.S. Pat. No. 6,472,203. But, under the current industry guidance, it is also expected that sample volumes of one cubic meter of air be tested at each sample location to qualify the clean room environments in pharmaceutical and biotechnology facilities. In most instances multiple sample locations are tested within a single room, which commonly leads to well over 100 test locations in a single pharmaceutical or biotech production facility. As such, it is also preferable and an industry expectation that air sampling devices be able to sample the desired volume of air in a short period of time, generally 10-minutes, achieved with a sampling rate of 100 LPM. As described, the air sampling cassette described in U.S. Pat. No. 6,472,203 only mentions a normal flow rate of 28.3 LPM, as is approximately used in the Anderson Sampler in U.S. Pat. No. 3,001,914. As sold by EM Labs, this remains the referenced flow rate for this device marketed under U.S. Pat. No. 6,472,203. With this flow rate it would take approximately 35-minutes to achieve a single Cubic meter sample, substantially increasing the required time and cost to sample a cubic meter of air.

### OBJECT OF THE PRESENT INVENTION

The object of the present invention is to provide a device for testing air for microbial content with all the inherent advantages of the prior art in slit impact air samplers, meaning that: the device offer the recognized microbial recovery ability of the slit impact air sampling methodology; the device offer a lengthy sample period which will minimize the number of manipulations required within the controlled environment; the device distributes the sampled air volume evenly over the test plate surface allowing for easy enumeration of microorganisms recovered; the device removes microorganisms captured on the test plate surface from the direct path of incoming sampled air, preventing their desiccation; the device allows for the determination of the time of organism recovery; the device is of a streamline size and shape that allows the device to be readily placed in controlled environments which may have minimal available work space, such as along pharmaceutical fill lines or within laminar airflow benches, so as not to be an hindrance to operations performed therein; the device is of a streamline size and shape that would have minimal disruptive affects on laminar air flow within a controlled environment so as not to jeopardize the integrity of that environment; the device operates remotely from operative controller means, whereby operative control means supplying vacuum and power to the device may be located outside the controlled environment greatly minimizing impact on controlled environments in which it is employed; and that all components of the device that are exposed to the environment may be easily and completely sanitized, or shall be pre sterilized, as monitoring of a controlled environment should not introduce additional contaminants into that environment.

But, in addition, the further object of the present invention of the single use air impact cassette with rotatable capture tray, in union with an operative base assembly is to provide a device which offers the following crucial advantages:

The cassette device provides an improvement upon existing designs in slit impact microbial air samplers in that it offers a self contained, sterile, single use, device, which will substantially reduce the risk of false positive testing results and operative cost. This can be achieved, as the integral sampling cassette itself will come terminally sterilized (e.g., standard Gamma, or E-Beam irradiation) and packaged, or sterile filled and packaged (e.g., manufactured and filled in a clean room) in a manner that would ensure the device retains its sterility until use, greatly minimizing false positive results. Additionally, the sterile device would not require sanitization by the user prior to use, lower operating cost associated with routine use for testing. The combination of the rotatable sample tray within a known sterile, single use sampling cassette, significantly ensures that anything captured during the sampling process is truly representative of the volume of air sampled.

The device provides improvement over known sieve impact air sampling cassettes with fixed captured medium, in that it provides a rotatable tray to support the capture media, beneath a slit type inlet orifice, within the cassette, which offers the full sampling advantages of a slit impact capture device, as previously described, while maintaining a relatively small profile when the cassette is removeably attached to an operative base, as to have negligible impact on the environment in which it is employed.

The device provides a platform for the use of a variety of capture medias which could then be analyzed by different techniques to offer an air sampling device which can keep up with continual advances in rapid microbial detection and other detection technologies which may benefit from an air sampling capture platform. For example, a filter material may be placed on the media within the capture tray of the cassette for microbial testing and after sampling, and minimal incubation, vital staining techniques may be employed (e.g., ATP fluorescence marking) on the filter for microbial recovery determination. Or, the rotatable capture tray may be replaced with one that retains a filter alone for surface of pass through capture. Or, an absorbent or adsorbent collection pad, or other known or future capture media may replace the agar medium with the capture tray, or filter on a filter support tray, or on other embodiments of the rotatable support tray. After testing these capture media may then be analyzed directly by a variety of techniques such as dark field analysis, including laser scanning, or digital imaging of the filter face. Or, by placing a filter onto or into a nutrient medium for microbial growth, or elution of the capture media into solution such that viable and non-viable particulates captured can be analyzed for presence of viral, or microbial components by RNA (e.g., through Transcription Mediated Amplification (TMA)), or DNA analysis techniques (e.g., Polymerase Chain Reaction (PCR) analysis), processed for chemical components (e.g., by HPLC analysis), evaluated for particulate matter captured by electron or standard microscopy, or other known or future analysis techniques that would benefit from an air capture platform.

### SUMMARY OF THE INVENTION

The single use sterile slit impact sampling cassette with rotatable capture tray of the present invention generally comprised of three primary structural components, a lid, a dish and a rotatable capture tray (tray), for collection of viable and non-viable particulate matter. In a first preferred embodiment, a cassette lid with an integral slit shaped air inlet, or inlets, is attached to a lower dish in a manner that creates a substantially sealed sample chamber in which a circular rotatable capture tray, which may maintain a variety of capture medias, is suspended between upper and lower cylindrical shafts which extend above and below the center of the circular capture tray. The top shaft is retained in a cup in the bottom center of the lid and its length in conjunction with the surface height of the capture media maintained by the tray, keep the top surface of the capture media at a preferred distance from the bottom of the lid and the output side of the air inlet within the chamber. A bottom shaft, formed on the bottom surface of the tray, is retained in a cylindrical aperture in the center of the dish floor and its terminal end is constructed to allow for easy mating with a drive means for rotation of the tray and capture media. An air outlet is formed through the dish floor to allow airflow through the cassette when vacuum is applied to the bottom of the cassette. The bottom of the dish is designed in a manner to allow for mating with a base structure for operation of the cassette. The dimensions of the dish, tray and lid allow for directed movement of air through the cassette, from the air inlet and then out through the air outlet of the sample chamber. The device is presented in a sterile manner, and includes a coverlid or sealing strip in place over both the air inlet and the air outlet to maintain the sterile integrity of the device until use.

The operative base of the present invention is a small cylindrical device which houses the drive motor to rotate the rotatable capture tray, with means to receive the drive motor operative power from a controller means, and means to then transfer operative rotation from the drive motor to the rotatable capture trays drive shaft. The operative base also employs means to attach and transfer vacuum from a controller means, which supplies a vacuum source to the cassette for air sampling. In the present invention, the operative base is attached to a controller means through a power cable and vacuum tubing assembly, which are quickly and easily attached or removed, to supply the required vacuum and power to the operative base. The operative base includes a sealing system to maintain the sampling cassette at the top of its structure, which allows for the transfer of the vacuum required for sampling from the controller means to the cassette for sampling. The vacuum, which is created during sampling, additionally maintains the cassette in place so that the driveshaft of the rotatable capture trays remains located in the drive motors attachment means, located in the center top of the operative base, during sampling with the device. The operative base is substantially sealed at all openings to minimize contaminant ingress and egress. Additionally, the device is virtually non-particulate generating and easily sanitizable.

### BRIEF DESCRIPTION OF THE DRAWING FIGURES

The following describes a single use, sterile, slit impact sampling cassette with a rotatable capture tray for recovering viable and nonviable particulate matter (e.g., bacteria, mold, viruses, viral particulates, spores, chemicals, etc.) from a sampled volume of air, in conjunction with an operative base for the supply of air flow through the cassette and rotational means for the rotatable capture tray. A more complete appreciation of the cassette and operative base and many of the attendant advantages thereof will be readily obtained as the same become better understood by reference to the following detailed description when considered in connection with the accompanying drawings, wherein:

FIG. 1 is an isometric top view of a sampling cassette separated from an operative base

FIG. 2 is an isometric bottom view of a sampling cassette separated from an operative base

FIG. 3 is an isometric view of a sampling cassette as removeably attached to an operative base for sampling

FIG. 4 is an exploded isometric top view of a sampling cassette detailing structures of the three primary components of a lid, a rotatable capture tray (tray), and a dish.

FIG. 5 is a an exploded isometric bottom view of a sampling cassette detailing structures of the three primary component, a lid, a tray, and a dish

FIG. 6 is an isometric view of a rotatable capture tray employed with an agar based capture media, and placed in a cassette dish with a cassette lid removed.

FIG. 7A includes separate cross sectional views of both a sampling cassette and an operative base, with the cassette positioned over the operative base, prior to attachment to the base.

FIG. 7B is a cross sectional view of a sampling cassette as attached to an operative base for sampling.

FIGS. 8A, 8B and 8C include three isometric views of an assembled sampling cassette with two functional inlet slits for use with a flow rate of 28.3 and 100 Liters Per Minute (LPM).

FIG. 8A shows a sampling cassette with both slit inlets covered to maintain the integrity of the sample chamber and contained capture media.

FIG. 8B shows a sampling cassette with the 28.3 LPM slit inlet cover removed for sampling.

FIG. 8C shows a sampling cassette with the 100 LPM slit inlet cover removed for sampling.

FIG. 9A is an exploded isometric view of an assembled sampling cassette, a cassette-to-base seal and an operative base assembly.

FIG. 9B is an exploded side view of an assembled sampling cassette, a cassette-to-base seal and an operative base assembly.

FIG. 10 is an exploded trimetric view of an operative base, and a cassette-to-base seal.

FIG. 11 is an isometric view of a sampling cassette as attached to an operative base for sampling with the operative base connected to a controller means supplying both vacuum for sample capture and power for turntable rotation.

FIG. 12A is an exploded isometric top view of sampling cassette components, as employed for use with a filter media, showing a lid, a rotatable filter platform, a filter media, and a dish.

FIG. 12B is an exploded isometric bottom view of sampling cassette components, as employed for use with a filter based capture media, showing a lid, a rotatable filter platform, a capture filter, and a dish.

FIG. 13 is an isometric view of the cassette with a rotatable filter platform and capture filter, in place within a dish with the lid removed

### DETAILED DESCRIPTION OF THE PREFERRED EMBODIMENTS

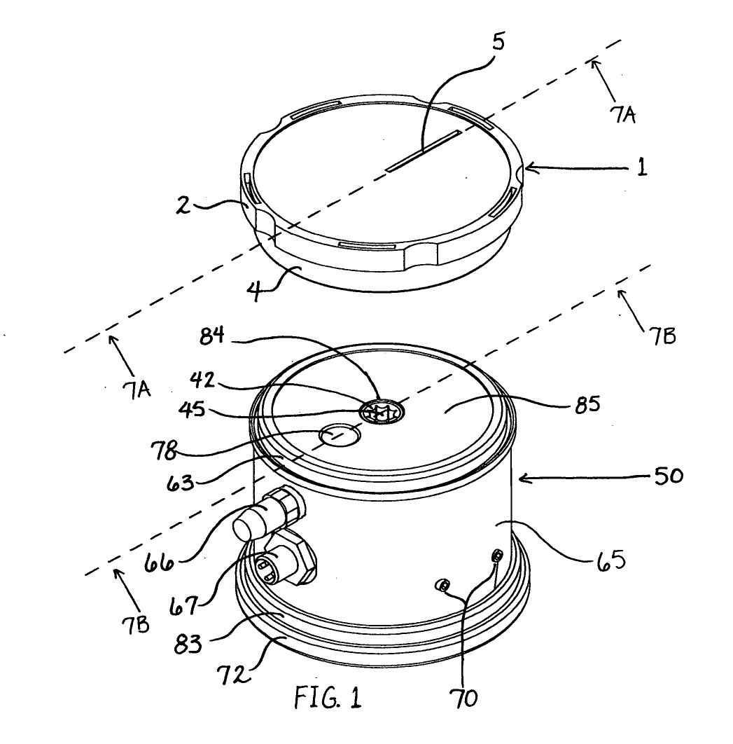

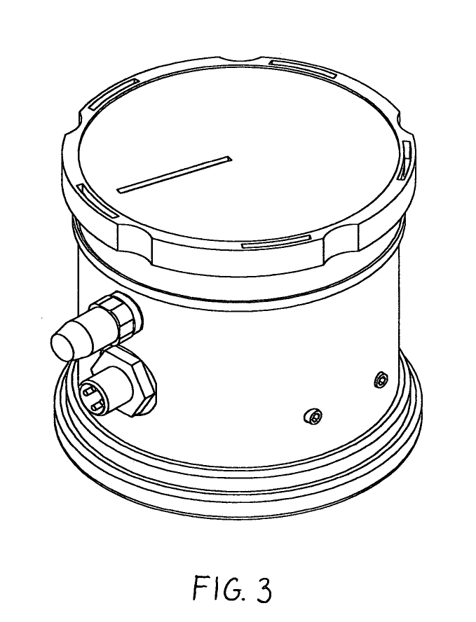

As detailed in FIGS. 1 through 11 a single use, sterile, slit impact sampling cassette with a rotatable capture tray (sampling cassette), according to the present invention is generally designated by reference numeral 1. The sampling cassette is approximately 0.925″ in overall height and approximately 3.85″ at its greatest diameter. The given dimensions, and others to be detailed, are not intended to limit the scope of the sampling cassette but are intended to better illustrate the small size of the unit when compared with the prior art in slit impact air samplers and for descriptive purposes to show general scaling of the structures of the device when associated with one another. In its current embodiment, sampling cassette 1 is designed to function in conjunction with an operative base 50, as depicted in FIGS. 1-3, 7a, 7b, 9a, 9b, and 13. The preferred embodiments of sampling cassette 1 structures, as intended for use as a single use device, in conjunction with operative base 50, are described in detail in the following text.

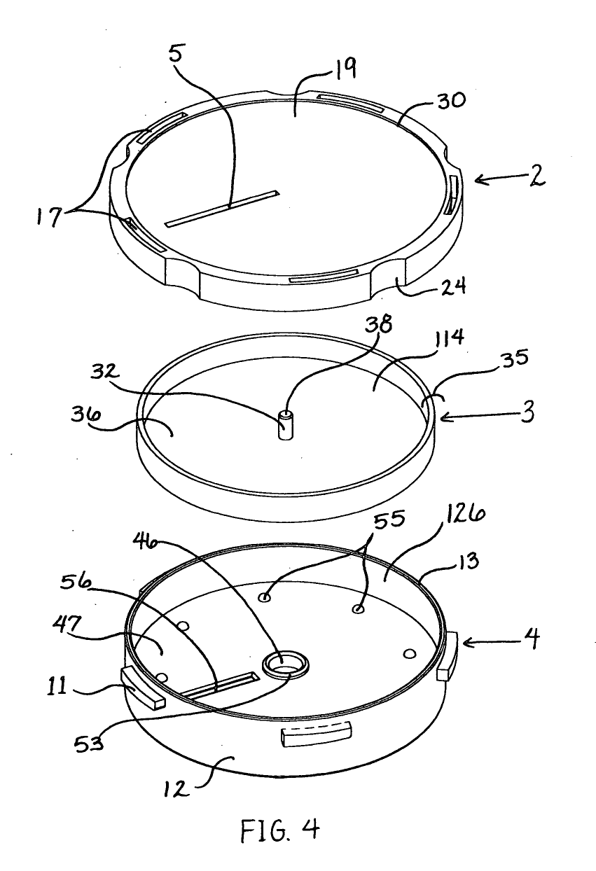

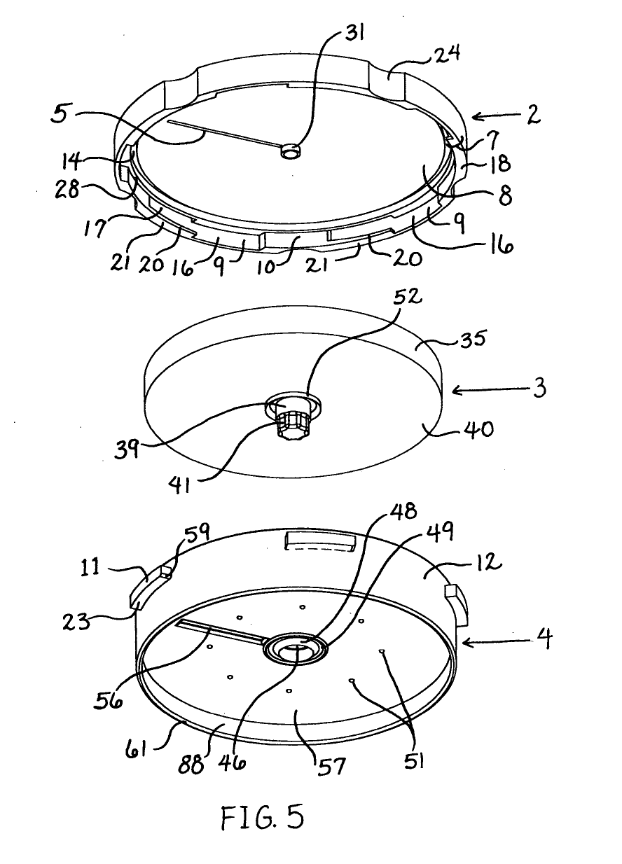

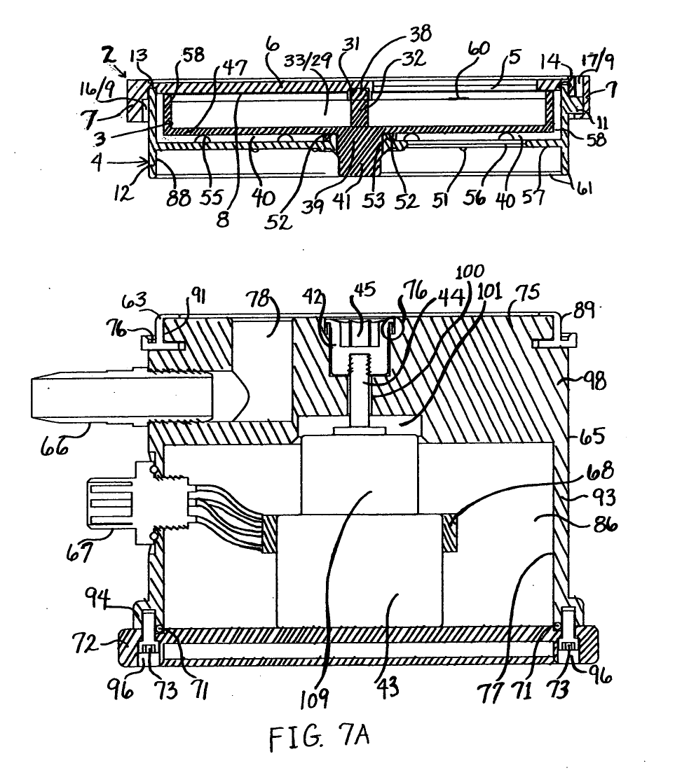

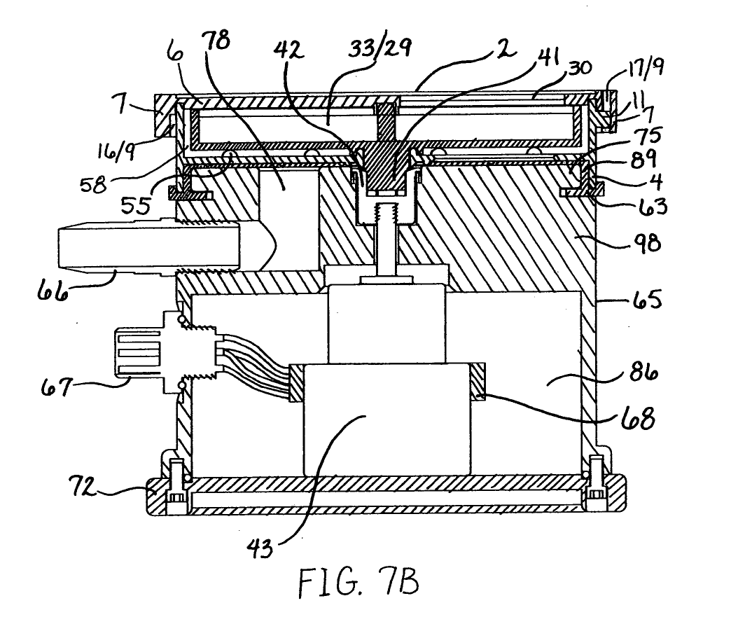

As best depicted in FIGS. 4 and 5, the sampling cassette is comprised of three primary structures, a lid 2 with an integral air inlet 5, a rotatable capture tray (tray) 3, to support a capture media, and a dish 4, which contains tray 3 and is attached and sealed to lid 2 to form a sealed sampling chamber 58, as depicted in FIGS. 7A and 7B. As depicted best in FIGS. 4 and 5, lid 2 of sampling cassette 1 is substantially circular in shape in shape with an outer diameter of approximately 3.85″. A stop structure 6 includes an exterior top surface 19 and an interior bottom surface 8. The material thickness of top structure 6, as best depicted in FIGS. 7A and 7B, of lid 2 is approximately 0.125″ with a outer lip 7 of approximately 0.250″ in overall height by 0.125″ in width around the circumference of lid 2 extending down from interior bottom surface 8 (FIGS. 5, 7A, 7B) of lid 2, perpendicular to interior bottom surface 8 of lid 2. In outer lip 7 is formed the lid 2 to dish 4 attachment means, attachment slot paths 9.

As depicted in FIG. 5, there are five attachment slot paths 9 employed in the principal lid 2 design that are evenly spaced around an interior wall 10 of outer lip 7 of lid 2. Attachment slots paths 9 allow lid 2 to fit over five attachment tabs 11 on a outer wall 12 of dish 4, and are similarly spaced and located and allow lid 2 to be rotated to be engaged with dish 4 attachment tabs 11, pulling lid 2 down onto dish 4 and tightly sealing a top edge 13 of dish 4 to lid 2 within a sealing channel 14 formed into the exterior perimeter of interior bottom surface 8 of lid 2 just inside outer lip 7. Sealing channel 14, is a shallow narrow channel formed into interior bottom surface 8 of lid 2 at a location just inside of a protective lip 28, and is substantially the diameter of outer wall 12 of dish 4, and the width of the wall thickness of outer wall 12. It is constructed in a manner to seal tightly against upper edge 13 when lid 2 is engage with dish 4.

As depicted in isometric view in FIG. 5 and in cross section in FIGS. 7A and 7B, of the preferred embodiment, the attachment slot paths 9 are formed into interior wall 10 of lid 2 outer lip 7 covered by the outer sidewall 15 of outer lip 7, which is approximately 0.050″ in wall thickness over the area of the attachment slots 9, protecting from contaminant ingress into the sample chamber. The vertical slot paths 16 of attachment slots 9 originate at a bottom edge 18 of outer lip 7 and are approximately 0.875″ in width and approximately a quarter of that dimension in height. Vertical slot paths 16 allow lid 2 to fit over attachment tabs 11 of dish 4 to allow for engagement with horizontal slot paths 17. Horizontal slot paths 17 originate from the vertical slot paths 16 and extend in a counter clockwise orientation when viewing lid 2 from the top surface 19. Horizontal slot paths 17 are approximately 0.750″ in width and slightly less than one half of the dimension in height as they rise to exterior top surface 19 of lid 2. The horizontal slot paths 17 have no top margin (FIG. 4) and open through to exterior top surface 19 of lid 2 and outer lip 7. In the principal design this is intended to allow for easier creation of the horizontal slot paths 17 within outer lip 7 of lid 2 by injection molding by a simple top and bottom mold tool without the requirement of slides or secondary operations. Horizontal slots paths 17 are contained at their lower perimeter by a retention tab 20 formed on interior wall 10 of bottom edge 18 of outer lip 7. As viewed in FIG. 5, a bottom surface 21 of retention tabs 20 are perpendicular to bottom edge 18 of outer lip 7 of lid 2, while the height of a top surface 22 of retention tabs 20 increases from approximately 0.030″ to 0.060″ from left to right, or as when viewed from the top of dish 4 when rotating lid 2 in a clockwise rotation onto dish 4. The increasing height of retention tabs 20 when rotated clockwise is designed to pull lid 2 down tightly onto dish 4 when engaged with the a contact surface 23 of dish 4 attachment tabs 11, which increase in height in a similar manner when rotated in a counter clockwise direction when view from the top of sampling cassette 1. Attachment tabs 11 are located at a point on dish wall 12 that ensures top edge 13 of dish 4 seals tightly with and against sealing channel 14 of lid 2 when slot paths 9 of lid 2 are engaged and rotated clockwise against dish 4 attachment tabs 11, thus forming a substantially air tight seal between dish 4 and lid 2, creating sample chamber 58. Other embodiments may include an additional seal with sealing channel 14, such as an O-ring, or flat seal, to seal, against top edge 13 of dish wall 12, if desired. This would require a slight height modification to the dish wall height to encompass the use of a seal, or location changes for the attachment tabs, but is a simple modification in design.

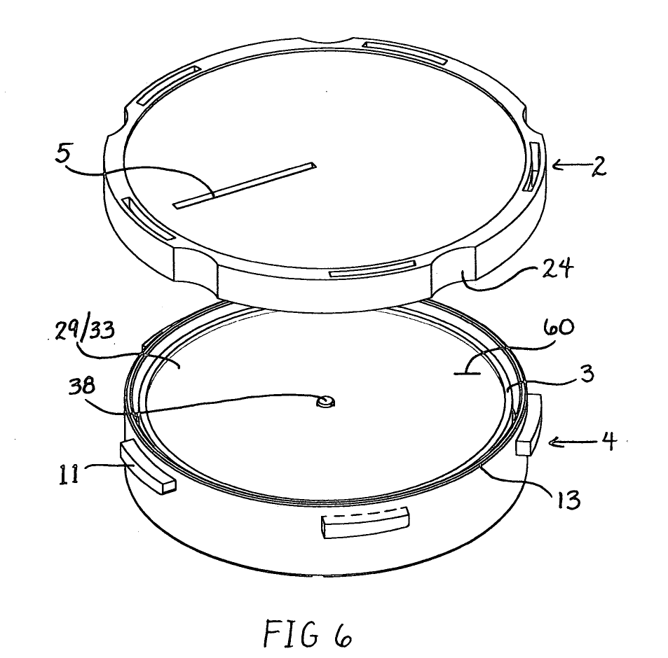

Additionally, the leading edges 59 (FIG. 5) of contact surface 23 are rounded, or chamfered slightly, to allow for easier assembly when attachment tabs 11 contact lid 2 retention tabs 20, when lid 2 is attached to dish 4. Between the five attachment slots 9, of outer lip 7 of lid 2, are formed semi circle reliefs 24 that will allow easier manipulation of lid 2 when attaching it to, or removing it from dish 4 for assembly and when performing final analysis of the capture media 29, depicted in FIGS. 6 and 13. Semi circle reliefs 24 are approximately one third to one half the thickness of outer lip 7.

As depicted in FIGS. 4, 7A and 7B, within the top surface 19 of lid 2 resides an air inlet 5. The principal design of air inlet 5 is the shape of a long narrow radial rectangular opening (slit) through top surface 19 of lid 2 of sampling cassette 1 at a location that would place it over the capture media on the sample tray. The length of air inlet 5 in the primary design is approximately half the diameter of a capture media 29 upon, or within, tray 3, with a width that would be appropriate for the airflow of the sample volume to assure an appropriate capture, or impaction speed. For example, a slit width of 0.007″ in conjunction with a slit length of 1.375″ and a sample rate through the cassette of 28.3 LPM, or 1 CFM would lend itself to a sample velocity of approximately 72 Meters per second, while a slit width of 0.013″ at the same sample rate (28.30 LPM) and length would offer a sample velocity of approximately 40 Meters per second; a slit width of 0.023″ with a slit length of 1.375″ at a sample rate of 50 LPM would offer 40 Meters per second; and a slit width of 0.046″ and length of 1.375″ at a sample rate of 100 LPM would also offer 40 MPS.

It is crucial to employ and maintain an appropriate sample impaction velocity, based on the size and type of the intended particulates of collection. In the preferred embodiment for microbial capture, the air inlets are sized as described for 40 meter per second capture velocities at those flow rate described in the examples above. But, as described, a variety of slit widths and lengths may be employed to optimize viable and non-viable particulate capture at differing flow rates. In the principal design, on the inlet side of the slit, or at the top surface 19 of lid 2, the slits are tapered from there initial opening in exterior top surface 19 of said lid 2 to the final desired slit width that emerges through the interior bottom surface 8 of lid 2. A slit shaped air inlet 5 as described is the preferred air inlet design. But, obviously other inlet shapes could be incorporated (e.g., a curved slit, or a plurality of small circular holes, or other geometric shapes, aligned in a radial pattern and of appropriate size), which would lend to the capture of a specified particulate type and/or size based on desired particulate size cut off, or capture values, in conjunction with a specific air (or gas) sampling rate, but that would lend themselves to capture on media on rotating tray 3 below air inlet 5.

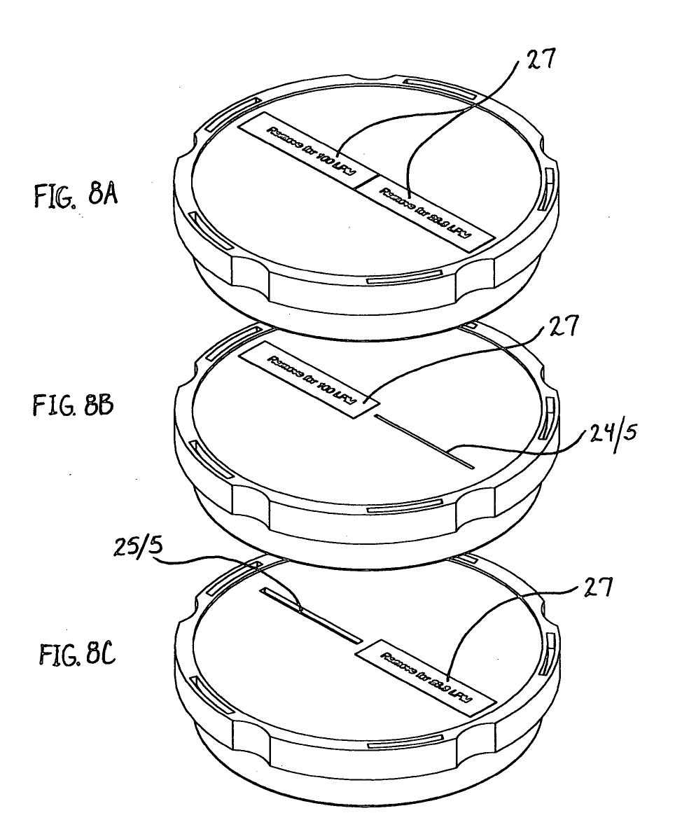

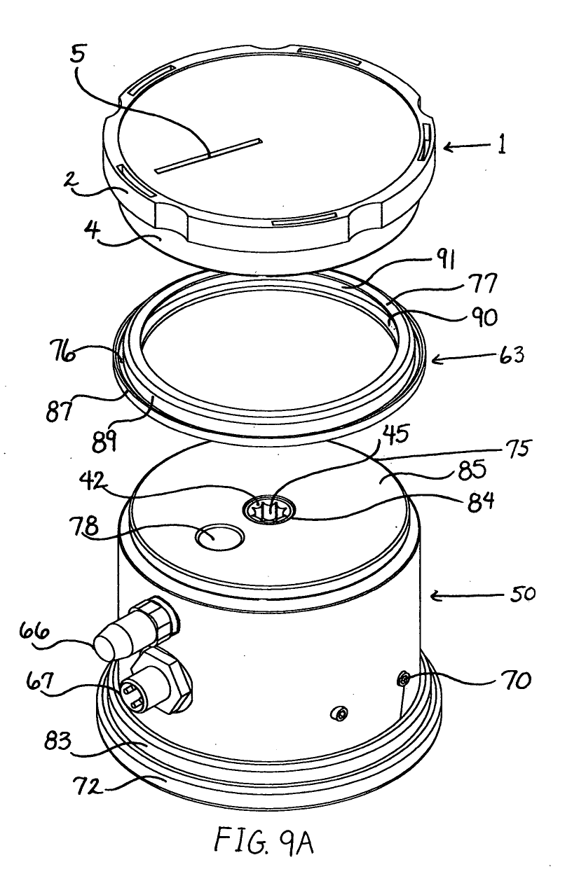

As best depicted in FIGS. 8A-8C, one or more air inlets 5 may be located within a single lid 2 upon manufacture, or lids 2 with different air inlets 5 may be manufactured to offer different modes of particulate capture to the end user. For example, as in drawing FIGS. 8A-8C of sampling cassette 1, within lid 2 reside both a narrower air inlet slit 25 and a wider air inlet slit 26 are created within exterior top surface 19 of lid 2 to offer the option of sampling at a lower (e.g., 28.3 Liters Per Minute (LPM)), or higher sample rate (e.g., 100 LPM), whilst still retaining the same capture velocity of particulates within the sampled air volume as previously described. Each air inlet 5 on lid 2 could initially be covered by a separate inlet seal 27 as depicted in FIGS. 8A-8C, with an adhesive backed plastic label covering air inlets 5 on the top surface 19 of lid 2. The user would simply remove an inlet seal 27 from the desired sampling inlet 5 before testing based on the desired sampling rate and/or volume, and sample desired capture velocity and then replace the inlet seal 27 to cover the air inlet 5 after sampling. Or, a secondary moveable lid cover (not depicted), as simple as a lid with a slightly larger inner diameter than lid 2, with a structure as may come on a standard nutrient agar plate, could be configured over the top surface of lid 2, and over lower edge 61 of dish 4, to cover a air outlet 56. Or, a lid may be configured that may rotated to expose just one of the air inlets 5 prior to sampling and then be rotated to cover the sampling inlet 5 after sampling. Other means could obviously be employed to reveal and cover the sampling inlet(s) 5, as long as they seal sampling inlet(s) 5 from contaminant ingress, or from unwanted airflow through an unused air inlet, if multiple sampling inlets 5 are employed in the lid 2.

Additional features of lid 2, as best depicted in FIGS. 5, 7A and 7B, include a protective lip 28 of approximately 0.062″ in height and 3.50″ in diameter runs around the interior wall of outer lip 7 and attachment slots 9 on interior bottom surface 8 of lid 2 at a location that would place it around the outer diameter of dish 4 when lid 2 is assembled to dish 4. Protective lip 28 is intended to add additional protection from ingress of contaminants into sample chamber 58, which in turn minimizes potential contamination of capture media 29 in tray 3. Also, as depicted in FIGS. 4 and 7A and 7B, the top surface 19 lid 2 is relieved slightly, forming a lid relief 30, approximately half the width of the wall thickness of dish 4, whereas lower edge 61 of dish 4 will fit in relief 30 of top surface 19 of lid 2 to allow for easier and more secure transport, storage and during incubation, and allowing secure stacking of multiple sample cassettes 1. A cylindrical cup 31 of approximately 0.140″ in diameter and 0.100″ in depth, with a minimal wall thickness is located at the center of the interior bottom surface 8 of lid 2, extending down from the described location, while also penetrating slightly into interior bottom surface 8. Cylindrical cup 31 retains top shaft 32 of tray 3 when lid 2, tray 3 and dish 4 are assembled.

Tray 3, depicted best in FIGS. 4-7B and 13, which resides within sample chamber 58, created between the assembly of lid 2 and dish 4, is substantially a short cylinder constructed to retain a capture media 29 such as nutrient agar media 33(e.g., for microbial organism capture); a filter media 34 (e.g., for microbial, or non-viable particulate capture); absorbent or adsorbent pads (e.g., for non-viable particulate, DNA, RNA or chemical capture); or adhesive material (e.g., for spore capture). In the principal design of tray 3 for retention of nutrient agar media 33, tray 3 is shaped as a circular disk and is approximately 3.250″ in outer diameter and 0.062″ in thickness. [0002] In the principal design tray 3 is manufactured with a side wall 35 running around the outer perimeter of tray top surface 36 and perpendicular to tray top surface 36, which in the principal design rises approximately 0.300″ in height above tray top surface 36, and is 0.062″ in wall thickness. In the current embodiment, tray 3 is designed to retain a volume of up to approximately 40 milliliters of nutrient agar media 33 for microbial recovery. Although, in additional embodiments it may be designed to support, or retain the variety of capture medias previously described for the capture and analysis of other particulate matter such as that of microbial or viral RNA, DNA, chemicals, plastics, metals, and other particulate matter that may be entrained by the device dependent on its intended set up.

As best depicted in FIGS. 4, 7A and 7B, tray 3 in the principal design includes a cylindrical upper shaft 32 of approximately 0.125″ in diameter extending upward from the top center surface of the tray by approximately two and one half time its diameter. Shaft top 38 of upper shaft 32 is rounded to reduce friction where it may be in contact with lid 2, within cylindrical cup 31, best depicted in FIGS. 5, 7A and 7B, to allow for ease of rotation. As depicted in FIGS. 5, 7A and 7B, an approximately 0.375″ diameter lower shaft 39 extends downward approximately 0.375″ from the center of tray 3 bottom surface 40. Approximately one half of the terminal end of lower shaft 39 is formed as an octagonal shaft 41. In the preferred embodiment, octagonal shaft 41 is of an octagonal shape that has been chamfered and rounded to easily fit into a similarly sized by slightly larger octagonal opening 45 of a mating bushing 42, of an operative base 50 (example FIGS. 1, 2, 3 and 9). When the cassette is placed on operative base 50, octagonal shaft 41 fits easily within octagonal opening 45 of mating bushing 42, which is attached to a motor shaft 44 of a drive motor 43 of operative base 50 (best depicted in FIGS. 7A, 7B, 9A and 10) for rotational means of tray 3.

As shown in FIGS. 7A and 7B, in conjunction with the height of capture media 29 maintained within, or upon tray 3, the lengths of the upper shaft 32 and lower shaft 39 are to be of a measure that locate the surface of the capture media 29 on tray 3 at an appropriate height from air inlet 5 to ensure appropriate particulate capture. In the preferred design the optimal distance between lid 2, air inlet 5, and media top surface 60 of capture media 29, in or upon tray 3, is 2-3 millimeters, but this distance may be altered upon manufacture of sampling cassette 1 for specific particulate capture requirements. When lid 2, tray 3 and dish 4 are assembled, upper shaft 32 of tray 3 resides within retaining cup 31 in the center of bottom surface 8 of lid 2. Lower shaft 39 of tray 3 resides within a cylindrical aperture 46, which opens through the center of an interior floor surface 47 of dish 4, and is of a slightly larger diameter than that of lower shaft 39, which allows for ease of rotation, but while still retaining a tight tolerance to minimize contaminant ingress. This configuration allows for attachment of octagonal shaft 41 to octagonal opening 45 of mating bush 42, of operative base 50, and allows for bottom shaft 39 to freely rotate within cylindrical aperture 46.

Additionally, centered on the bottom surface of tray 3, surrounding the bottom shaft is a cylindrical protrusion, protective ring 52 (FIG. 5), which is perpendicular to the bottom surface extending downward approximately 0.062″ and is 0.600″ in outer diameter and approximately 0.050″ in width. When tray 3 is assembled to dish 4, protective ring 52 fits loosely over a raised lip 53 of cylindrical aperture 46 at the center of interior floor surface 47. When the cassette components are assembled (FIG. 7B), this configuration minimizes the chance of contaminant ingress into the cassette during operation of the device and assists in maintaining the bottom surface of tray 3 at a defined distance form interior floor surface 47, allowing directed airflow beneath tray 3 and through sample chamber 58 when vacuum is applied to sampling cassette 1.

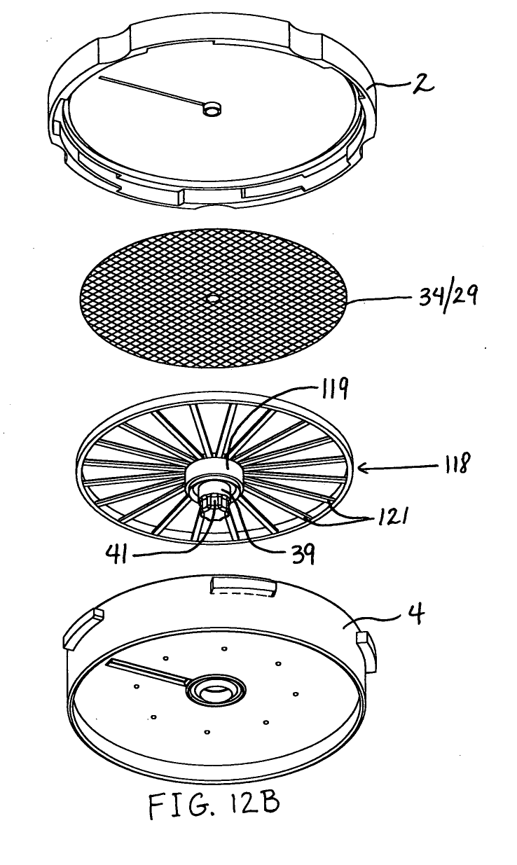

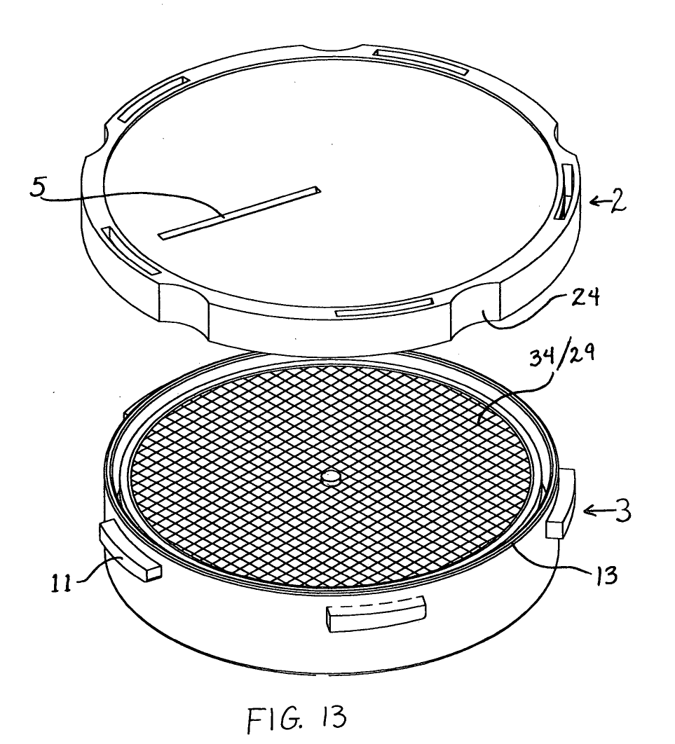

Additional embodiments of the rotatable capture tray may be desired and employed. On example of an additional embodiment of a rotatable capture tray may include a rotatable filter support 118, depicted in FIGS. 12A, 12B and 13, which would be compatible and function within the confines of sample chamber 58 of the preferred embodiments of the device as described for lid 2 and dish 4, but with modifications to the rotational capture tray. In place of a rotatable capture tray to support a capture media, a rotating filter support platform 118 is employed, to support a filter media 34. Filter platform 118, in its current embodiment, includes a plurality of equally spaced radial tines 121 span between a central support structure 119 at the center of filter platform 118 to the outer circumference of a support ring 120, defining the outer circumference of said filter platform 118, which is substantially equivalent to the outer circumference of tray 3, previously described. Central support structure 119 is cup shaped to minimize the mass of material employed for manufacture of the part by injection molding. The overall height of support ring 120, as well the height of maintained radial tines 121 is approximately one half to one third of that of tray 3 side wall 37, while the combined structure of upper shaft 32, lower shaft 39 and octagonal shaft 41, are employed in substantially the same manner as for tray 2, to maintain and allow rotation of filter platform 118. Support ring 120 and radial tines 121, place media filter 33 at the same distance from air inlet 5 entering into sample chamber 58 at interior bottom surface 8 of lid 2, as that of a capture media 29 upon tray 3. The use of filter platform 118 may be employed with a filter capture media, which may vary based on the desired particulates of capture. Radial tines 121 of filter platform 118, employ a wedge shaped top surface 121 and are space apart in a manner to allow for a sample air volume to be drawn easily through said filter capture media, so as to entrain particulate matter with the sampled air volume within the structure of said filter media located on said filter platform 118. With this configuration, air inlet 5 of lid 2, is aligned with air outlet 56 of dish 4, lending to a more direct path of air immediately through the filter capture media 34. This is just one example of an additional embodiment of the rotatable capture tray, others may obviously be employed for specific capture medias, but ideally are able to employ the same primary structures of dish 4 and lid 2.

As best depicted in FIGS. 4, 5, 7A and 7B, the primary dish 4 design is substantially that of a short cylinder approximately 3.5″ in outer diameter by 0.750″ in height with an approximately 0.062″ circular platform 117 dividing the top two thirds of the cylinder from the bottom third of the cylinder, creating a interior floor surface 47 with upper wall edge 13 and a exterior bottom surface 57 with lower wall edge 61, with a air outlet passing from interior floor surface 47 through to exterior bottom surface 58. On the dish floor top surface 114 are eight equally spaced half around stand-offs 55 (FIG. 4). In the current embodiment stand-offs 55 are approximately 0.062″ in radius and are equally spaced on an approximately 1.360″ radial path, around the center of dish floor 47. The series of standoffs 55 ensure tray bottom surface 40 is supported off the dish floor 47 as it rotates (FIG. 7B), creating and maintaining a path for air flow, allowing for air flow under tray 3 and through sample chamber 58, with air entering sample chamber 58 through air inlet 5 and then exiting through air outlet 56, while creating little friction against bottom surface 40 of tray 3 while the sampled air volume is being impinged against the capture media 29 located on tray 3, when vacuum is applied and tray 3 is rotated. On exterior bottom surface 57 (FIG. 5), of dish 4, there are eight similar but smaller equally spaced half around stand-offs 51. The series of half round standoffs 55 ensure exterior bottom surface 57 is supported off of top surface 85 of operative base 50, creating and maintaining an air flow path under exterior bottom surface 57 of dish 4, allowing for air flow through the sampling cassette 1, entering sample chamber 58 through air inlet 5 and then exiting through air outlet 56, and then through airway 78 opening in the top surface 85 of operative base 50, when vacuum is applied.

As best depicted in FIGS. 4, 5, 7A and 7B, in the center of interior floor surface 47, of dish 4, is formed cylindrical aperture 46, which is approximately 0.380″ in diameter and 0.150″ in height by 0.380″ inner diameter shaft cylinder with an outside wall diameter of 0.500″. Cylindrical aperture 46 projects downward approximately 0.062″ from the center of exterior bottom surface 57 of dish 4 forming cylindrical protrusion 48. When tray 3 is assembled to dish 4, bottom shaft 39 of tray 3 slip fits into cylindrical aperture 46, with octagonal shaft 41 exposed past cylindrical protrusion 48. Cylindrical protrusion 48 is chamfered to allow an easier fit into mating bushing 42, depicted in FIGS. 1, 2, 7A and 7B. The top surface of mating bushing 42 (partially depicted in FIG. 7A) is tapered from its peripheral edge towards its center by approximately 0.100″ to allow for easier placement of octagonal shaft 41 in octagonal opening 45 of mating bushing 42. The top edge 53 of cylindrical aperture 46 rises slightly above dish floor 47 by approximately 0.062″ and is approximately 0.500″ outer diameter, surrounding the interior diameter of cylindrical aperture 46. Top edge 53 is rounded to fit easily into protective lip 52 of the tray 30 to reduce potential contaminant ingress into sample chamber 58. Additionally, surrounding cylindrical protrusion 48, on exterior bottom surface 57 is formed spacer ring 49 (FIG. 5). Spacer ring 49 is approximately 0.700″ in outer diameter, 0.600″ in inner diameter and 0.031″ in height and maintains the center of exterior bottom surface 57 at a specified distance from operative base 50 top surface 85. Spacer ring 49 in conjunction with half round standoffs 51, and a cassette-to-base seal 63, maintain dish floor bottom surface off of base top surface 85, allowing for directed airflow through the cassette when sealed to operative base 50 and it also disallows any air flow through cylindrical aperture 46 in which bottom shaft 39 is located, when vacuum is applied to operative base 50, although this would not impact the sampling event.

An air outlet 56 is created through interior floor surface 47 between cylindrical aperture 46 and dish wall 12. As depicted in FIGS. 4 and 5, of the current embodiment, air outlet 56 is rectangular in shape and is located between lower interior wall surface 88, and spacer ring 49 of exterior bottom surface 57, while not merging with either structure, and being approximately of a measure from lower interior wall surface 88, as not to be partially occluded by seal 63 of base structure 50. This location allows for the more direct draw of the sampled air volume through the cassette when pass through filter configuration 118, is employed and lid 2 is attached to dish 4 with air inlet 5 in alignment with air outlet 56. But, in most standard impaction configurations additional embodiments of air outlet 56 may actually take any functional geometric shape, as long as the total area of the air outlet 56 is sized to be greater than or equal to that of the area of largest air inlet 5 employed within lid 2, as not to create a limiting orifice which may limit the required airflow through the cassette, and likely create the need for a strong vacuum source for sampling. In the preferred embodiment, the air outlet may be located at almost any location on interior floor surface 47, but between the two structures as previously defined to function in conjunction with the current embodiment of operative base 50 to supply vacuum to the cassette. But, the air outlet may be located on dish wall 12 if the vacuum source would be attached from the side of dish 4, but ideally below the level of the capture media. When the cassette is assembled, the air outlet (or vacuum inlet) allows for air to be drawn in through air inlet 5 of lid 2, when a vacuum source is applied to air outlet 56. The air and contained particulate matter is then impinged upon the media located on the tray. In the current embodiment air outlet 56 is an aperture, but the sample outlet may be formed as a hollow cylindrical protrusion “a barb” (not depicted) that allows for airflow between sample chamber and outer wall 12 of dish 4 and allows attachment to a vacuum source. If employed, the barb should be designed to allow for a substantially sealed connection to the vacuum source (e.g., tubing or operative base fitting). Air outlet 56 is employed with a cover (not shown), but substantially similar to that of air inlet covers shown in FIGS. 8A-8C, which would be maintained in place up to use of the device, and then replaced after use of the device, as a barrier to contaminant ingress.

As depicted in FIGS. 4, 5, 7A and 7B, and as previously describe, on dish wall 12 are five attachment tabs 8 in the principal cassette design. Tabs 8 are approximately 0.750″ in width and 0.125″ in initial height and extend off the dish wall 12 by approximately 0.125″. The top surface 20 of each attachment tab 11 is level and parallel to the top edge 13 of dish 4, while the bottom surface 55 decreases in height from left to right by approximately 0.030″. Attachment tabs 11 are designed to engage with attachment slot paths 9 of lid 1, previously described, to tightly seal upper edge 13 of dish 4 within sealing channel 14 of lid 2 when lid 2 is assembled to dish 4. Tabs of different dimensions, or differing in number, or other means such as mating threads in lid 2 inner wall 10 of outer lip 7 and dish wall 12 (e.g., a lid and jar design), clamping means, or other means could be designed to secure lid 1 to dish 4 to obtain a tight integral seal between the two components.

The principal assembly of the cassette as used for microbial air sampling is as follows. Tray 3 is assembled to dish 4 by placing bottom shaft 39 of tray 3 fully into the cylindrical aperture 46 so octagonal shaft 41 is completely exposed past cylindrical protrusion 48 of exterior bottom surface 57. Tray 3 may be filled with the desired capture media, such as nutrient agar, or and adsorbent pad, filter pad, or other desired capture media may be placed on the capture tray before or after this step. Lid 2 is then assembled to tray 3 and dish 4 by aligning cylindrical cup 31 in the center bottom surface 4 of lid 2 over shaft top 38 of top shaft 28 of tray 2. Vertical slot paths 16 in outer lip 7 of lid 2 are then aligned with attachment tabs 11 on dish wall 12 and lid 2 is then placed upon dish 4. Lid 2 is then rotated clockwise to engage the attachment tabs 11 into horizontal slot paths 17 to tighten top edge 13 of dish 4 and seal lid 2 into sealing channel 60 forming a substantially sealed sample chamber 58. The seal between lid 2 and dish 4 may be obtained with, or without an additional sealing material (e.g., O-ring, or flat seal) within the top edge 11 of dish 4, or within sealing channel 14 of lid 2.

Adhesive inlet seals 27, or a secondary cover over top surface 19 of lid 2 are removeably attached to cover air inlet(s) 5 on top surface 19 of lid 2. Adhesive outlet seal 62, or other protective cover, is put in place over air outlet 56. The assembled and sealed cassette may then be packaged individually, or in quantities, in a sealable pouch of plastic, Tyvek®, or other suitable material. As the cassette is intended for sampling use during aseptic operations it would be preferred to double bag, if not triple bag the cassette for layered protection for passage into critical zones for use. This may include separate packaging of individual cassettes and then placing several individually packaged cassettes within a second, if not a third package. The packaged cassettes could then be bulk packaged (e.g., multiple packages of packaged cassettes within another package) and terminally sterilized by Gamma, or E-Beam irradiation to fully reduce any microbial contaminants that were picked up during the assembly and filling process. The cassette may also be assembled, filled, sealed, and packaged aseptically in a clean room environment to achieve an adequate level of sterility if desired.

The sampling cassette components may be constructed from a variety of plastics, glass, or other known materials. The components may be created by a variety, or combination of forming processes including injection molding, stereo lithography, thermo-molding, or vacuum-forming, in conjunction with secondary machining operations if required, or could be machined completely from stock materials. Other means currently known, or processes that may be available in the future could be used as well, as long as they meet the desired endpoint for each component. The material(s) and process of choice would likely be those that would minimize the cost of manufacture and allow for a terminal sterilization of the assembled and packaged unit by standard gamma irradiation or E-Beam irradiation (e.g., both services available from sources such as the Steris Corporation, base in St. Louis, Md.), or other known sterilization means. The materials should also be clean room friendly and should not shed substantial particulate matter, or outgas any chemicals that would be of concern in the environment in which they may be employed. Injection molding is the primary choice of manufacture in for the current embodiment, using materials such as polystyrene for the lid and tray, with polyethylene used for dish 4. Ideally a softer material is used for the dish 4 which will allow it to better seal to lid 2. Ideally lid 2 would produced from a material that would offer optical clarity to allow viewing of the media located on the tray, but this is not required for its operation.

Obviously, with these teaching, the cassette could be designed in a manner that would make it smaller, or larger in proportion. It would also not have to be created in cylindrical, or circular. form, with the likely exception of the tray and capture media, which lies within the sample chamber of the cassette. Additionally, the device could be manufactured in a manner and of materials to allow for re-use of the cassette components if desired to lower operating cost and minimize waste. Reuse of the lid and dish components is possible with the potential for replacing the capture media for each use. If appropriate materials of manufacture are chose, the lid, tray and dish, could be cleaned and steam sterilized (i.e., autoclaved), chemically sterilized, or by other means by users prior to incorporating a new, or newly clean/sterilized and filled tray with the desired media.

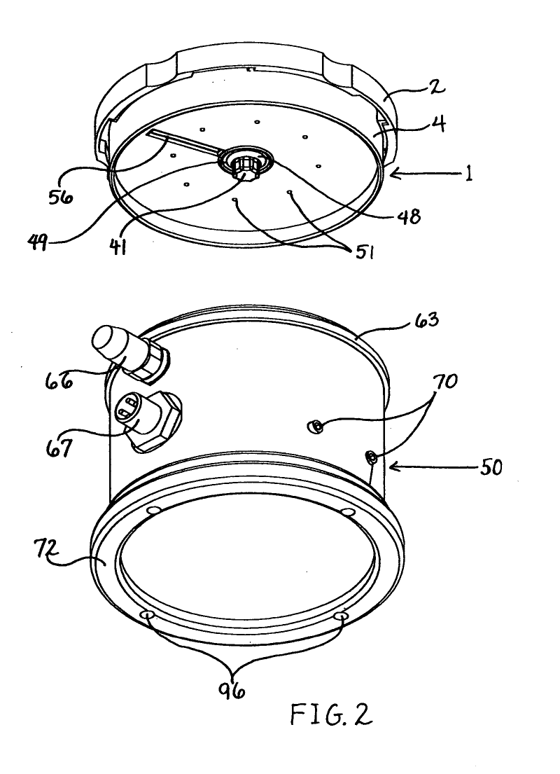

As depicted in FIGS. 1, 2, 3, 7A, 7B and 9A-11 the operative base of the current embodiment is generally designated by reference numeral 50. Operative base 50 is approximately 3.00″ in overall height and approximately 4.00″ at its greatest diameter. These dimensions are not intended to limit the scope of the operative base but are intended to better illustrate the preferred small size of the unit. As depicted in FIG. 2, operative base 50 is comprised of base assembly 64 and cassette-to-base seal 63. The components of operative base 50 are further described in general detail.

As best depicted and detailed in FIG. 7B, cassette-to-base seal 63 seals sampling cassette 1 to operative base 50 when vacuum is applied to hose barb 66, forming a substantially air tight seal between sampling cassette 1 and the base sealing structure 75. This allows air to be drawn through airway 78 which initiates at the side of base structure 65 and opens in base top surface 85, which is located beneath exterior bottom surface 57 of dish 4, when sampling cassette 1 is placed onto operative base 50, allowing for air to be drawn through lid 2 air inlet 5 into sample chamber 58 impinging upon capture media 29 residing in or upon tray 3 and then exiting through air outlet 56 into air pathway 78 and then exiting out of base structure 65 through hose barb 66 which attaches to air pathway 78 on exterior base structure 65.

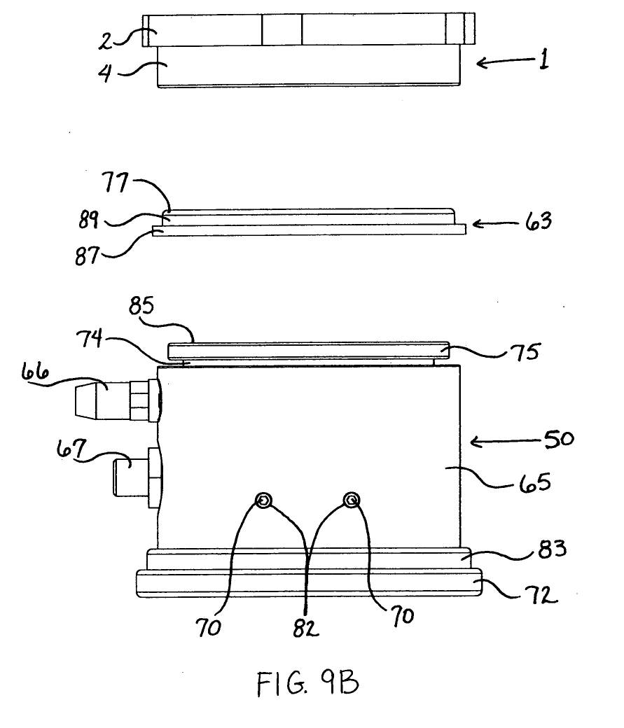

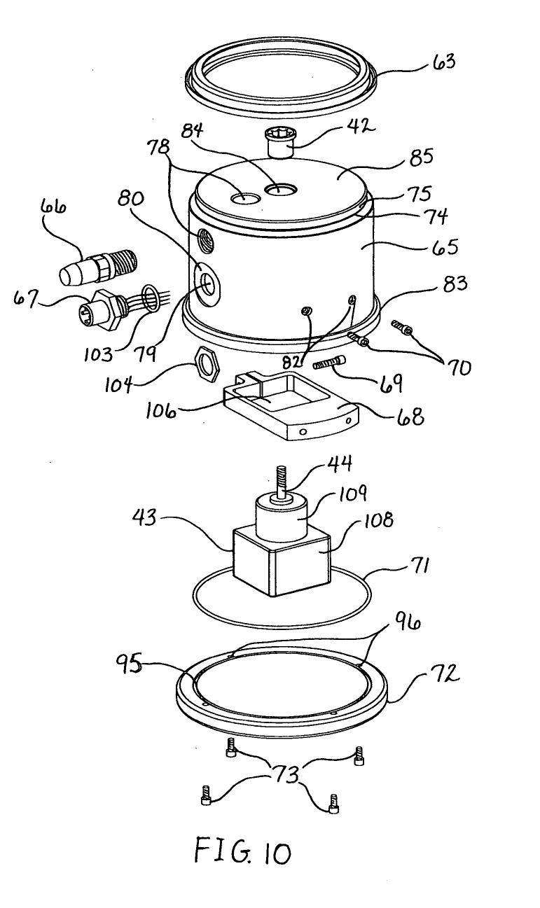

As best detailed in FIG. 9A, Cassette-to-base seal 63 is approximately 3.625″ at its largest outer diameter (OD) (the outer perimeter of seal outer lip 87), is 3.00″ at its smallest inner diameter (ID) (the interior diameters of both sealing surface 77 and retaining flange 90), and the total height of the seal is approximately 0.313″. In between sealing surface 77 and retaining flange 90, is sealing wall inner surface 91 which is approximately 3.250″ in ID and 0.220″ in height. Seal outer lip 87 is approximately 0.125″ in width and 0.125″ in height and runs around the entire lower perimeter of cassette-to-base seal 63. Sealing groove 76 (FIG. 9A) is a channel of approximately 0.062″ in width and depth formed into seal outer lip 87 the OD of seal groove 76 is approximately 3.500″ and runs around the entirety of the top surface of seal outer lip 87. The outer diameter of the inner wall of sealing groove 76, sealing wall 89, is approximately 3.38″, which is slightly larger than the inner diameter of dish inner wall 88, best depicted in FIGS. 5 and 7A. Sealing groove 76, of seal 63, maintains and seals to bottom edge 61 of dish 4, as wells as the lower portion of dish outer wall 12 and inner wall 88. Sealing wall 89 rises approximately 0.250″ from the bottom inner edge of sealing groove 76 and is approximately 0.062″ in thickness. The height of sealing wall 89 is the approximate distance between dish bottom edge 61 and dish bottom surface 57 depicted in FIGS. 7A, 7B and 9A). At the top inner diameter of sealing wall 89 is sealing surface 77 which extends at approximately 0.130″ at a 90° angle from sealing wall 89 towards the interior of the seal and is approximately 0.031″ in thickness giving a total width of sealing surface 77 of approximately 0.192″. At the interior diameter of the bottom margin of the seal is located retaining flange 90 which extends approximately 0.125″ at a 90° angle from sealing wall 89 towards the center of the seal and is approximately 0.062″ in thickness.

Seal groove 74 (FIGS. 9A and 9B) is located approximately 0.210″ from base top surface 85 and is approximately 2.900″ in OD and 0.077″ in height. The perimeter of seal mounting structure 75 is of a slightly smaller OD than the interior diameter of sealing wall interior diameter 91, or approximately 3.200″, to allow for compression of the seal when the cassette is placed onto the seal, and to allow for variation in finish coatings. This is also true for seal groove 74, which has been slightly oversized to allow for placement of the seal on seal mounting structure 75 and to allow for variation in finish coatings, such as an epoxy polyester paint powder coat, anodized finish (e.g., clear, hard, or color anodized), or other sizing variations if the base structure is formed by injection molding, machined out of a variety of metals, or plastics, or other processes currently known, or that may be developed.

As depicted in section FIG. 7A, Cassette-to-base seal (seal) 63 is removeably attached to base structure 65 by enveloping the top and side perimeters of seal attachment structure 75 (FIGS. 7A, 7B, 9A and 9B) of base structure 65 between retaining flange 90 and sealing surface 77 of seal 63. Retaining flange 90 is inserted into seal groove 74 formed into the outer diameter of base structure 65, while sealing wall interior diameter 91 and the interior surface 92 of sealing surface 77 surrounds the perimeter of the seal mounting structure 75 as well as approximately 0.125″ of the outer edge of base top surface 85. Sealing surface 77 has two functions. First, it seals against the perimeter of dish floor bottom surface 57 when sampling cassette 1 is in place in the seal and vacuum is applied to hose barb 66. Second, it maintains the perimeter of dish floor bottom surface 57 off of base top surface 85, in conjunction with small half rounds 51 and spacer ring 49 to allow for air flow between airway 78 and air outlet 56 of sampling cassette 1. The defined configuration of seal 63 and seal mounting structure 75 also alleviates the requirement for adhesives to mount seal 63 to seal mounting structure 75, allowing seal 63 to be routinely removed and replaced for sanitization or other purposes.

In its current embodiment, Cassette-to-base seal 63 is molded out of silicone, or fluorosilicone, and is fairly pliable, as to form a substantial seal between components, yet rigid and elastic enough to put it in place over seal mounting structure 75, but is able to retain its original shape to seal properly to sampling cassette 1. A variety of materials may be used to make seal 63 such as Viton®, butyl rubber, or other elastic materials. However, it is preferred that the materials have the qualities of being low particulate shedding and be able to withstand repeated disinfectant procedures by a variety of chemical disinfectants and steam sterilization procedures. Instead of incorporating attachment mechanisms into the seal as in the current embodiment, other seal means may be employed. For example, a flat, circular gasket, or O-Ring sandwiched between the cassette and operative base, with clamping mechanisms employed to hold the cassette tightly against the base top surface may be employed.

As depicted in FIGS. 7A, 7B, 9A, 9B and 10, is the main support structure of operative base 50, base structure 65. Base structure 65 is cylindrical in shape and is approximately 3.500″ in outer diameter and 2.75″ in height. A seal groove 74 and seal mounting structure 75, as previously described, are formed in the top 0.285″ of the top portion of structure, cylindrical block 98. Hollow interior 86 of base structure 65 is cylindrical in shape, being substantially closed at its top margin, but open to the bottom of base structure 65. Hollow interior 86 (FIGS. 7A and 7B) is approximately 1.625″ in height and 3.250″ in diameter and houses the rotational means for tray 3, which includes drive motor 43 and motor mount 68. The material thickness between the interior and exterior surfaces of base structure 65, comprising a trunk 93, allows for mounting of these components. A laterally extending lower flange 94, approximately 3.750″0 and 0.250″ in height, encircles the perimeter of the bottom edge of the base. Lower flange 94 of base structure 65 allows attachment of a base cover 72, which seals hollow interior 86 of base structure 65 from the environment in conjunction with base cover screws 73 and O-ring seal 71. The lip of base cover 72 may also be utilized for removeably affixing the operative base to other surfaces, or structures.

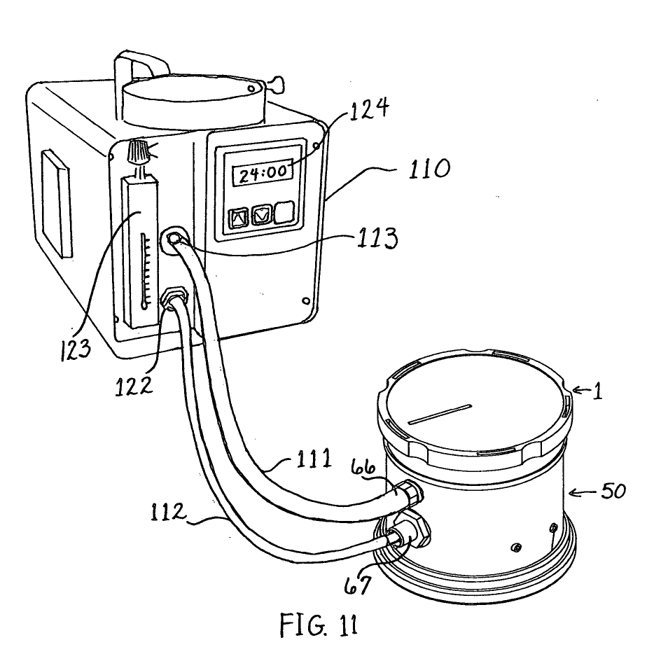

As depicted in FIGS. 2 and 10, base cover 72 is circular in shape and is approximately 0.325″ in height and 4.000″ in outer diameter. A 0.062″ O-ring channel 95 is formed in the top surface of base cover 72, to retain O-ring 71, which is 0.062″ in cross sectional diameter and approximately 3.375″ in outer diameter. This configuration will allow for a substantial seal with the bottom surface of base structure 65, just outside the perimeter of the opening of the hollow interior. At a location just outside of O-ring channel 95 are formed clearance holes 96 for base cover screws 73. In the current embodiment, the base cover is attached to the base with 4 base cover screws 96, which are evenly spaced around the perimeter of the O-ring channel every 90 degrees. But, obviously other means of attaching the base cover could be used (e.g., threading the base cover to the base structure), although the cover should be removable and replaceable for assembly, maintenance and repair purposes.

As depicted in section in FIG. 7A and 7B, the upper portion of base structure 65 interior materials, above hollow interior 86, has not been significantly excavated. This portion of the base structure, a cylindrical block 98, is approximately 1.125″ in thickness. Within this portion of base structure 65 is formed airway 78, seal mounting structure 75 (previously described), bushing aperture 84, motor shaft pathway 100, and motor excavation 101. As best depicted in sectional FIGS. 7A and 7B, airway 78 is approximately 0.500″ in diameter and runs horizontally, approximately 1.200″, through cylindrical block 98 from the exterior side of base structure 65, located at about 0.700″ on center below base top surface 85. Airway 78 then travels vertically through cylindrical block 98 opening at the top surface of the base. Airway 78 is tapped (threaded) (FIGS. 7A, 7B) at the side of base structure 65 to accept hose barb 66 (FIG. 1, 9A), which has mating threads. This allows for attachment of a vacuum means to airway 78. When sampling cassette 1 is attached to operative base 50, the opening of airway 78 opening at base top surface 85 allows air to be drawn into sample chamber 58 of sampling cassette 1 through air inlet 5 in lid 2, impinging the sampled air volume upon capture media 29 rotating on tray 2 within sample chamber 58. The sampled air volume then exits sample chamber 58 through air outlet 56 and is then evacuated from operative base 50, through the airway 78 and hose barb 66. Additional embodiments may employ other means, such as utilizing a variety of tubing and vacuum fitting combinations, to create an airway, which would allow air to be drawn into the top of the base structure and then evacuated from the base.

As depicted in FIGS. 1, 7A, 7B, 9A, and 10, bushing 42 slip fits and rotates within bushing aperture 84 in the center of base top surface 85. Mating bushing 42 is approximately 0.500″ in height and is 0.575″ in diameter around bushing flange 115, which is approximately 0.075″ in height, the base of the bushing is 0.475″ in diameter and approximately 0.425″ inches in height. The center of the top is relieved to a depth of approximately 0.250″ in a manner to easily accept octagonal shaft 41 of tray 3. Mating bushing 42 is attached to motor shaft 44 of drive motor 43, which is mounted within hollow interior 86 of base structure 65, by means such as threading of the shaft and drilling and tapping of the bottom of mating bushing 42, but could be attached by other known means. The preferred embodiment of mating bushing 42 is manufactured from Delrin® or Teflon®, as both materials have good bushing properties, offering ease of rotation and sealing properties within bushing aperture 84. To aid in creating a seal between bushing aperture 84 and mating bushing 42, as depicted in FIGS. 7A and 7B, the underside of bushing flange 115 includes a sealing channel 76 that fits over sealing lip 105, which surrounds the exterior perimeter of the interior diameter of bushing aperture 84. This configuration disallows direct contaminant ingress into the interior of base structure 65,

As depicted in many of the drawings, including FIGS. 1, 2, 7A, 7B, 9A, 9B and 11, below hose barb attachment port 38 of base structure 65 is electrical port 79. Electrical port 79 is an opening in the exterior side of base 30 through the trunk into hollow interior 86 (FIGS. 7A and 7B), which accommodates electrical connector 67. Electrical connector 67 transfers power from the controller means, by way of a power cable 14 depicted in FIG. 14, to drive motor 43 (FIGS. 7A, 7B and 10) mounted within hollow interior 86 of the base. Drive Motor 64 is operatively wired to the electronic receptacle by solder or other means. In the current embodiment, electrical connector 67 (FIG. 9A) is a Con-X-all® 4-Pin Connector, available from numerous electronics suppliers. Its primary structure is aluminum, with a formed plastic interior, which maintains the 4 contact pins and associated wiring. The electrical connector 67, with an O-ring seal 103 (a component of electronic receptacle 67) is threaded into trunk 93 of base structure 65 from the exterior, and the threads of a locking ring 104 (a component of electrical connector 67) are engaged with the threads of electrical connector 44 which extend into hollow interior 86. Locking ring 104 is adequately tightened to secure electrical connector 67, to trunk 93. A spot face 116 is present around electrical port 80 to allow for flush mounting of electrical connector and to allow for clearance of the hexagonal shape of electrical connector 44. The electronic connector described is for illustrative purposes as it is compact and has substantial air and watertight sealing capabilities, which minimize the chance of electrical hazard. A variety of electrical connectors may be used in additional embodiments, which would offer the same preferred characteristics.

Depicted in FIGS. 7A, 7B and 10, is the turntable drive mechanism employed in the current embodiment of the operative base, which is comprised of a drive motor 43 and motor shaft 44. In the current embodiment, drive motor 43 is an electric stepper motor, although other means such as a clock type mechanism may be incorporated as the tray 3 drive mechanism in additional embodiments. Rotation of the tray 3 and capture media 29 is crucial to the desired function of the sampling cassette 1. Firstly, the rotation removes non-viable and viable particulate matter from the direct path of incoming air from the sample slit after they have been impinged or captured on the test plate. This keeps microorganisms and other particulate matter from desiccating and thus allows for a lengthy sample period. Secondly, the rotation evenly distributes the captured particulate matter over the test plate surface. This even distribution allows for easier enumeration of [0002] particulate matter recovered as it is not impinged or captured upon previously captured matter. Thirdly, the rotation permits determination of the time of recovery of the particulate matter, as the rotational distance of the test plate is equivalent to a known time period. Determination of the recovery time then allows for correlation of recovered contaminants with specific operations under way in the controlled environment.

In the current embodiment of operative base 50, drive motor 43 may have a variety of rotational speeds if appropriately validated for microbial or particulate recovery. Differing rotational speeds are desirable, as an environment with a high density of airborne microorganisms, or other contaminants, may require a higher rotational speed of tray 3 and capture media 29, than an environment with fewer contaminants. As stated previously, when tray 3 is rotated faster the contaminants that are captured am spread out more evenly over the entire capture media 29 surface as opposed to being captured on top of one another, allowing more accurate enumeration of the contaminants recovered in a highly contaminated area Different rotational speeds may be obtained by means such as varying gearing of the turntable drive mechanism or by altering the cycles of electricity to the turntable drive mechanism, as is possible when an electric stepper motor is employed. Whatever the rotational speed, it is preferred that the capture media be exposed for sampling for no more than one full rotation, as the same portion of the test plate should not pass the air inlet more than once for reasons including: over exposure and desiccation of microorganisms, or other particulate matter, which were captured on the test plate during the first exposure; capture of microorganisms or other particulates upon one another making enumeration difficult; and the inability to estimate the recovery time of microorganisms captured as it would not be known at which rotation the microorganisms were recovered.

Referring to FIGS. 7A, 7B and 10, in the current embodiment of operative base 50, drive motor 43 is mounted to interior wall 107 of base structure 65 by a motor mount 68. Motor mount 68 is attached to interior wall 107 with a pair of motor mount screws 108, which are employed and retained from the exterior side of the base through screw holes 82, through the trunk, roughly 90° from electrical port 67. An opening 106 through the center of the mount, approximately matching the outer perimeter of motor base 107 of drive motor 43, accepts motor base 107. The motor mount 68 opening 106 location aligns drive motor 43 and motor shaft 44 with the center of base structure 65 and shaft pathway 100 and motor top 109 within motor excavation 101 of cylindrical block 98. The motor is affixed in place in the motor mount with a clamping screw 69 which brings together the ends of motor mount 68, which are initially separated by a small gap of approximately 0.062″ but other suitable means of attachment are of course possible. The drive motor 43 is mounted at a location in motor mount 68 which places the motor shaft 44 at a height that allows for attachment to mating bushing 42. Additional embodiments may include modifications to the mounts design in order to retain the motor within the interior or in which to incorporate the use of other motors in additional embodiment. In the current embodiment of the operative base, motor mount 66 is manufactured from 6061-T6 aluminum but other materials such plastics or stainless steel may be employed.

As an object of the operative base 50 is to assure that the device does not contaminate the controlled environments in which it is utilized, the interior of operative base is sealed in an substantially air tight manner from the exterior environment to prevent contaminant ingress and egress. As such, entrance holes into the interior of the base from the exterior, which are utilized for mounting of components described heretofore, are substantially sealed. In the current embodiment of the operative base this objective is obtained by the means previously described and as summarized below.

As depicted in FIGS. 7A, 7B and 10, O-ring seal 71 is sandwiched between the mating surfaces of base cover 72 and base structure 65, sealing the largest opening into the base hollow interior 86 in a substantially air and water tight manner. Furthermore, electrical connector 67 in conjunction with O-ring 103 ensures a substantially air and water tight seal between the exterior and interior surfaces of base structure 65 substantially sealing the electrical port. Further, the tight tolerances between mating bushing 42 and bushing aperture 84, in conjunction with the sealing channel 76 and sealing lip 105, substantially reduce any chance of contaminant egress or ingress at this opening into operative base 50 as well.

With this arrangement contaminates may not enter or leave the base interior and as such can not, influence the samples gathered with the sampling cassette and may not add to the viable or non-viable particulate load of the controlled environment, products, or test materials which may be manipulated therein: Additionally, this seal arrangement allows the cassette base to be easily and completely cleaned and sanitized, as all surfaces left exposed to the environment are sanitizable with chemical disinfectants. Of course, additional embodiments may employ a variety of means for sealing entrance holes made into the interior for attaching components to the base. This may include the employment of gaskets, sealants, or other means, in place of, or in conjunction with O-Rings for sealing entrance holes into the base interior disallowing contaminants ingress and egress. Although, it is preferred that other means employed allow ease of assembly and disassembly of components.

In the current embodiment, the base is manufactured from aircraft grade, 6061-T6 Aluminum. Aluminum was employed in the current embodiment for its lightweight and durable properties, as the unit is portable and may be moved from location to location and additionally for its substantial resistance to chemical sanitization procedures. In the current embodiment, the base cover is manufactured from 316 Stainless Steel, as it should be durable and resistant to chemicals being the primary contact surface with other structures during use, storage and transport. The surface finish of the described components is essentially non-porous and non-particulate generating. The non-porous finish employed disallows entrapment of particulate matter and allows complete cleaning and sanitization of the surface which may be performed using a variety of disinfectant agents such as quaternary disinfectants, alcohol, bleach, hydrogen peroxide, or other commonly used disinfecting agents.

The operative base itself could be of a variety of shapes such as a small cube, or cylinder and would only need to be up to a few inches in height and width, or diameter. The main structure could be fabricated from a variety of plastics such as ABS™, Kydex™, polycarbonate, or metals such as aluminum, or stainless steel, or a variety of other materials that would be compatible for the environment in which the device is to be deployed for use. Additional embodiments of base structure 65 and base cover 72 may include construction from a variety of materials including alternate grades of aluminum such as 6061-T5, 6061-T3, 2024-T4, corrosion resistant stainless steels, titanium, bi-metals, plastics, or other materials that would offer the same structural functionality. The base structure and base cover may be formed by a variety of methods such as molding, casting, or machining, or may be formed from a combination of molding or casting and machining or otherwise. Surface finishes of aluminum may include, but are not limited to, standard anodizing (i.e., clear, blue, red, gray, or black finish), hard anodizing, or chromic anodizing. Painted finishes may be employed, such as epoxy and polyester powder coat finishes, but would have to be of durable, high quality non-shedding, non-toxic paints, able to withstand sanitization methods described. In the preferred embodiment, the paint may be an epoxy and polyester mix. Preferably, the materials and surface finish must not generate or harbor particulate matter, which could contaminate the environment in which the operative base is to be utilized and must be resistant to repeated sanitization procedures described previously.

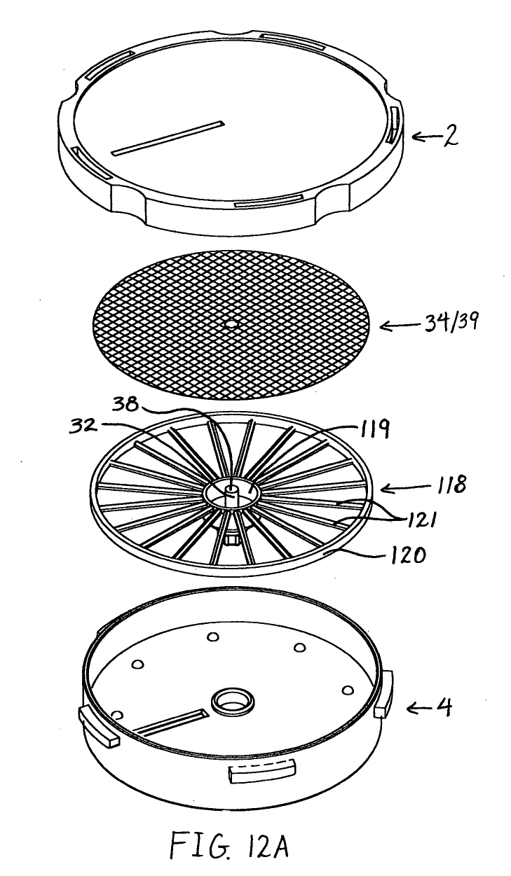

In the current embodiment of invention, as depicted for illustrative purposes in FIG. 11, is controller means 110. Controller means 110 is connected to an in house power supply and is functionally wired to operate supply power to a vacuum means housed within the controller means and to supply and control this vacuum to the operative base. Controller means 110 also includes means to supply and control power for the drive motor in the operative base. As depicted in FIG. 11, operative power is transferred from a controller means 110 to drive motor 43 mechanism in operative base 50 through power cable 112, a Con-X-all 4-Pin cable assembly with both male and female connection ends. The female, or 4-socket end of Power cable 112, mates with electrical connector 67, a 4-pin male configuration mounted on the exterior side of the base structure, while the other male, or 4-pin end of the power cable 112 is connected to a 4-socket female electrical connector 122 mounted to the exterior of controller means 110 (Electronic connectors described are available from numerous electronics distributors). The connectors described are for illustrative purpose as they employ characteristics that are preferred in the current embodiment of the operative base. Other comparable wiring, connectors and fittings, which would transfer power from controller means 110 to operative base 50, may be utilized in additional embodiments. However, it is preferred that other power cable assemblies allow for quick connect and disconnect capabilities, be compact in size and offer sealing means which substantially minimize electrical hazard.

Vacuum line 111 transfers airflow from the vacuum means housed in controller means 110 to operative base 30. One end of vacuum line 111 is removeably attached to hose barb 66 threaded into airway 78 of operative base 50 and the other end to a controller vacuum attachment 113 mounted on the exterior surface of controller means 110, which is functionally plumbed to a, vacuum source contained within the controller means, or external to the controller means (e.g., house vacuum). The hose barbs and vacuum tubing allow airflow between operative base 50 and controller means 110 and are preferred to be constructed from non-shedding materials that are resistant to chemical and steam sterilization procedures. Further, an adjustable flow controller 123 housed by the controller means controls the volume of air to be sampled, should be employed to allow for different flow rates through the cassette (e.g., 28.3 LPM, 50 LPM, or 100 LPM).

Control of operative power to drive motor and vacuum means supplying air flow to the operative base and thus the sampling cassette could be affected by connecting or disconnecting the primary power supply cable from the controller means to the power outlet. While this is all that is strictly necessary, it is preferred that the controller means include additional means for controlling the operation of these mechanisms. The controller means may include a manual on/off switch mounted upon its exterior. An indicator may also be employed to indicate if the house power supply to the controller means is on or off and in turn that power and vacuum are being supplied to the operative base. Alternatively, or additionally, the control means may include a sample timer mechanism 124. The timer might include an appropriate start/stop button and a display area which will visually display the output of the timer and which may be an LCD, LED, or other display arrangements. It is preferred that the timer be operatively coupled with the on/off switch for automatic control of the turntable drive mechanism and vacuum means. For example, the timer and on/off switch may be connected such that operation of the switch will place the device in standby mode, with operative power being supplied to the turntable drive mechanism and the vacuum means only upon the operator pressing the start/stop button of the timer. The timer could then automatically count down the desired time period and automatically deactivate the turntable drive mechanism and vacuum means upon expiration of this time period. In such an arrangement, it is preferred that the timer include a set button or buttons which will allow the user to set a predetermined time period of operation for the turntable drive mechanism and vacuum means. This is just one example of such controller means. It is not the intent to describe the full embodiment of a controller means, which may operate the operative base and thus the sampling cassette

As stated, the aforementioned example is for illustrative purpose. Other controller means arrangements are of course possible for control of the operative base. These may include a remote control set up which may allow the user to set the sample time period on the controller means and initiate sampling from the location of the operative base, or elsewhere, by means of either infrared, radio control, or by wires directly connected to the controller means. Further, a vacuum pump may not be employed in the controller means and as such an in house vacuum source may be utilized, although it may be operatively controlled through the controller means. Further, if the turntable is rotated by a means that does not require an electrical power source, such as a clock type mechanism, the operative base may be employed only with an in-house vacuum source. As such, a flow meter to control the airflow through the sampler may be the only controller means required.

### Operation

For operation of the current embodiment of the single use sterile slit impact sampling cassette with rotatable capture tray, the sampling cassette is connected to the operative base unit by removing the sampling cassette from its sterile packaging, removing the cover seal over the air outlet on the bottom of the cassette, and then placing it in the cassette-to-base seal at the top of the operative base, while assuring the octagonal shaft is oriented appropriately in the octagonal opening in the top of the mating bushing in the top of the operative base. The operative base in turn is, attached to a controller means through a length of tubing for vacuum which is attached to the hose barb on the operative base and length of power cabling, which is attached to the electrical connector on the base.

Immediately before testing, the air inlet cover on the cassette lid is removed and then a sample cycle on the controller means is initiated. During operation, the vacuum created by the airflow through the cassette holds and seals the cassette to the base unit. The applied vacuum source draws the required volume of air through the air inlet in the lid, accelerating it to a desired velocity, to insure the impingement, or entrainment of particulate matter from the sampled air volume onto, or within the capture media on the tray rotated beneath the air inlet incorporated into the lid of the cassette, within the sample chamber created with the mating of the lid and dish. The sample air volume is then evacuated from the sample chamber of the sampling cassette through the air outlet at the bottom of the cassette. The sampled air volume is then drawn through the airway initiating at the top of the operative base and then out through the hose barb, into and through the vacuum tubing and then into the controller means where the sample volume is exhausted.

At the completion of the test cycle the controller means is stopped, or may stop automatically, the cassette is then removed from the base and both the air inlet and outlet are recovered for transfer to testing facilities (e.g., laboratory) for analysis. The cassette may be placed within additional packaging for transport as well to minimize exposure. As stated, analysis performed will be dependent on the intent of testing and the type of capture media employed. This may include a variety of capture medias and analysis techniques. This may include, but is not limited to use of microbial nutrient growth medias, filters, adsorbent materials, absorbent materials, adhesive materials, or other capture medias. While analysis may include, but is not limited to standard, or rapid microbial methods, including standard plate incubation and colony counts, followed by microbial identification of organisms recovered, or ATP fluorescence marking and detection; RNA analysis by Transcription Mediated Amplification (TMA); DNA analysis by Polymerase Chain Reaction (PCR) Analysis; HPLC analysis for chemicals, metals, plastics, etc.; electron or standard microscopy of the capture media, and other techniques that may benefit from an air sampling platform. As the volume of air sampled per specified time period is known, the density of contaminants present per volume of air can then be determined. Moreover, as the rotational speed of the turntable is known the time of particulate capture may also be determined.

### SUMMARY

As described in the preferred embodiment, the device improves upon existing designs in that it provides a single use, sterilizable, self contained, slit impact unit with a rotatable capture tray that minimizes the loss of viable and non-viable particulates captured due to desiccation. This is possible, as the tray is rotated during operation; the captured particulate matter is not subjected to the direct path of incoming air during the entire sampling process. The use of the sterile sampling cassette will ensure end users that anything captured during the sampling process is truly representative of the volume of air sampled. This cassette will also minimize the time spent cleaning and sterilizing non-disposable units and significantly minimize the risk of “false positive” results. The captured particulate matter can then be assessed for its intended purpose of capture. For example, microorganisms impinged upon an agar surface can be incubated for the determination of growth, a capture filter can be processed (e.g., laser scanned) for the determination of the presence of viral, or microbial components, or an absorbent, or adsorbent collection pad may be processed for chemical components (e.g., HPLC analysis), or particulate matter captured can be assessed by microscopy, laser scanning, etc.

From the foregoing it will be seen that this invention is one well adapted to attain all ends and objects herein above set forth together with other advantages that are obvious and inherent to the structure. As described heretofore, the overall streamline structure of the sampling cassette in conjunction with an operative base causes minimal obstruction to laminar (unidirectional) airflow in controlled environments in which it may be utilized, such as Class 100 to 100,000 clean rooms, or support areas, such as those found in pharmaceutical and biotechnology manufacturing facilities and hospitals. Further, the streamline structure allows placement of the sampling cassette and operative base in locations in controlled environments, which have minimal available workspace, such as along pharmaceutical fill lines or within laminar airflow benches used for testing. Additionally, sealing of all entrance holes into the operative base interior, in a substantially air tight manner, substantially minimizes the risk of contaminant ingress and egress, whereby protecting the controlled environment from undesired contaminants. Also, the choice of materials employed for manufacture which are resilient to sanitization procedures, as well as the non-porous surface finish employed, shall surely minimize the chance of contaminating controlled environments by allowing complete, routine, sanitization of the operative base. Furthermore, the physical separation of the controller means from the device, with means for allowing it to be operated remotely, greatly reduces the inherent risks of contamination of, and obstruction to, operations performed in controlled environments. By these means, the cassette and associate operative base are fashioned to be much more suitable for utilization in controlled environments than the prior art in slit impact, and single use sieve impact air samplers.

Obviously many modifications and variations of the present invention are possible in light of the above teachings. For example, dimensional changes internally and externally to the sampling cassette structures, or the operative base may of course be acceptable to accommodate alternate components used in additional embodiments of the invention (i.e., capture medias, drive motors, mounts, connectors, airway plumbing, etc.). Or, the sampling cassette could be mounted directly to a controller source and operated directly at that location, without the need for an operative base. As such, the overall dimensions of the described structures may be varied and shapes other than the cylindrical shape described in the current embodiment of the invention may be employed such as oval, spherical and square or rectangular with, or without rounded edges. But, as described in the text, the production and maintenance of the cassette in a sterile manner in combination with the substantially streamline shape and size of the combination of the sampling cassette and operative base are crucial to the utility of the unit and should be taken into consideration.

It is, therefore, to be understood that while specific embodiments have been shown and discussed, various modifications may of course be made without departing from the scope thereof. Also, it will be understood that certain features and subcombinations are of utility and may be employed without reference to other features and subcombinations. This is contemplated by and is within the scope of the claims. As such, it is to be understood that all matter herein set forth or shown in the accompanying 16 drawing is to be interpreted as illustrative, and not in a limiting sense.

The embodiments of the invention in which an exclusive property or privilege is claimed are defined as follows:

1. A single use, sterile, slit-to-agar sampling cassette with rotatable capture tray and a capture media for the collection of viable and non-viable particulate material from ambient air, said apparatus comprising:
a lid attached to a dish forming a sealed sample chamber in which a rotatable capture tray is suspended;
said lid is substantially a circular structure having an exterior top surface and an interior bottom surface including an outer lip surrounding and extending down from the outer diameter of said interior bottom surface and integral to said interior bottom surface, with said outer lip having a slightly larger interior dimension than a outer wall of said dish;
said lid employing a centrally located a cylindrical shaft cup, for the retention of a upper shaft of said tray;
said lid having an air inlet opening through said exterior top surface of said lid, into said sample chamber;
said air inlet shaped as a long, narrow, rectangular slit, located in a radial position within said top surface, while being of an overall area that will cause a desired air speed velocity for capture of target particulates when vacuum is applied to said sampling cassette, with said air inlet sized and located in a manner to be positioned substantially over a radial portion of said capture media upon said tray, or substantially half the diameter of said capture media;
said lid employed with a protective lip running around the perimeter of said interior bottom surface of said lid, but within a inner wall of said outer wall, to reduce potential contaminate ingress, with a continuous circular shallow sealing channel formed just within said protective lip of said interior bottom surface, with said sealing channel in a location that will place in sealing arrangement and direct contact with said upper edge of said outer wall when said lid is attached to said dish;
said lid employed with a plurality of formed reliefs in a outer circumference of said outer lip to allow for easier handling when attaching or removing said lid to, or from, said dish;
said lid employed with attachment means to join with said dish;
said dish being substantially cylindrical divided by a circular structure, with a interior floor surface and a exterior bottom surface, with a air outlet passing from said interior floor surface through to said exterior bottom surface;
a raised upper wall surrounding the perimeter of the interior floor surface and integral with said interior floor surface, with said upper wall of a slightly smaller diameter than the inner diameter of said outer lip of said lid, with said exterior bottom surface having a raised lower wall surround the perimeter of the exterior bottom surface and integral with said exterior bottom surface, with said upper wall and said lower wall being of the same dimension creating a confluent cylindrical wall around said exterior bottom and said interior top surfaces;
said upper wall having an upper edge in substantially similar dimension and alignment to fit and seal within said sealing channel of said lid;
said lower wall having a lower edge, with said lower in substantially similar dimension and alignment fit and seal within a base seal mounted on a operative base structure;
said dish including a central cylindrical aperture opening through said interior floor surface opening to said exterior bottom surface, with central cylindrical aperture configured to accept a lower shaft of said tray, with central cylindrical aperture including a small raised lip surrounding a outer perimeter of said cylindrical apertures on said interior floor surface, and with a raised shaft lip surrounding said outer perimeter of said cylindrical aperture on said exterior bottom surface, with a spacer ring surrounding said raised shaft lip, employed to maintain a center of said exterior bottom surface at a preferred height from said top surface of said operative base to allow for directed airflow between the structures;
said dish employed with attachment means to join with said lid;
said tray is as a short cylinder having a bottom surface and a top surface and a side wall surrounding and integral to said top surface for the retention of a capture media;
said tray top surface employed with a capture media retained within said side walls;
said tray is substantially suspended and centrally located at a consistent height within said sample chamber of said dish by a cylindrical upper shaft rising from said top surface and a cylindrical lower shaft descending from the center of its bottom surface, a protective ring encircles said lower shaft on said bottom surface of said tray, with said protective ring residing over said small raised lip of said dish when said lower shaft of said tray is placed in said cylindrical aperture, forming a substantial contaminant barrier between the two structures;
said tray is moveably mounted within a interior bottom surface of said lid and a interior top surface of said dish;
said upper tray shaft is moveably maintained within a cylindrical shaft cup extending from the underside of said lid;
said lower shaft moveably maintained within said cylindrical aperture, and extending through the center of a interior floor surface of said dish to a exterior bottom surface of said dish, exposing a lower portion of said lower shaft beyond said large raised lip of said cylindrical aperture, with a dimension that substantially aligns a terminal end of said lower shaft with said lower edge of said lower wall of said dish;
said tray outer wall is of smaller dimension than a upper wall interior of said dish, allowing for free movement during rotation of said tray within said upper wall interior of said dish and allowing directed airflow through the open space created;
said tray said outer wall height, said upper shaft and said lower shaft, are of a dimension that places said capture media and said tray below said interior bottom surface of said lid, allowing for rotation of said tray, with said capture media, within said interior walls of said dish and below the height of said lid, and when said lid is attached to said dish, with said capture media upon said tray, said capture media is at an optimal distance from said bottom surface of said lid and said air inlet for particulate capture on said capture media located on said tray, within said sealed sample chamber, onto which particles drawn through said air inlet may be impinged when a vacuum is applied to said air outlet of said sampling cassette;
a removable and replaceable cover over said air inlet, and a removable and replaceable cover over said air outlet to prevent contaminants from entering said sealed sample chamber;
a means for the flow of air into said sample chamber through said air inlet and out of said air outlet;
and a means for rotational movement of said tray.

2. The sampling cassette of claim 1 wherein said interior floor surface of said dish is employed with a plurality raised half round standoffs integral with said interior floor surface and spaced apart evenly from each other on equal but separate radial paths between said upper interior wall and said cylindrical aperture at the center of said interior floor surface, so as to form a circular pattern around said interior floor surface, at a location that would place said half round stand offs closer to a outer edge of said tray bottom surface, so as to maintain said bottom of said tray at a desired height from said dish said top interior surface;
said half round standoffs support and maintain said tray said bottom surface above said interior floor surface at a consistent height to create an path for airflow beneath said tray and through said cassette from said air inlet to said air outlet;
said half round standoffs support the perimeter of said tray and maintaining a top surface of said capture media at a desired distance from the air inlet when air is impacted against said capture media upon said tray while said tray is rotated, causing little friction, allowing for ease of rotation.

3. The sampling cassette of claim 1 wherein said exterior bottom surface is employed with a plurality of raised half round standoffs integral with said exterior bottom surface and spaced apart evenly from each other on equal radial paths between said lower interior wall and said dish sides so as to form a circular pattern around said bottom surface of said dish at a location between the center of the dish floor and said dish said interior wall, so as to maintain said bottom surface of said dish at a desired height from a top surface of a operative base, to which said dish is attached for operation, allowing for directed airflow between a airway in a top surface of said base to said air outlet of said dish, to allow for directed airflow between a airway in said top surface of said base to said air outlet within said dish of said sampling cassette.

4. The sampling cassette of claim 1, wherein said attachment means of said lid to said dish comprise a tab and slot attachment system, wherein said tab and slot attachment system comprises a plurality of tabs integral with said outer wall of said dish, with said lid including a complimentary number of said attachment slot paths integral with said inner wall of said outer lip of said lid, said tabs and slot paths formed for complementary rotatable attachment and removal, but substantially attach said lid to said dish, causing a substantially air tight tolerance between said upper edge of said dish and said sealing channel of said lid.

5. The sampling cassette of claim 1 operated in conjunction with a base for operation;
said base being substantially the shape of small cylinder with a an outer diameter of substantially the same dimension of said dish outer diameter, and of a height only as substantial as required to house required components for support and operation of said sampling cassette;
said base employed with a short cylindrical top structure of a height that is substantially that of a lower wall height of said dish and of a outer diameter that is slightly smaller than that of the interior diameter of said lower wall;
said base top structure constructed to maintain a cassette-to-base seal in a manner that does not require adhesives, or other additional components, while allowing for ease in routine removal and replacement of said seal;
said base employed with means for transfer of vacuum to said cassette consisting of a airway passing from a side of said base through to a stop surface of said base at a location that will place it beneath said dish when placed on said seal, with a vacuum connector attached to said air pathway at said side of said base for attachment to a vacuum source;
said seal constructed in a manner and of a dimension which generates substantial contact with and seal to said dish at said dish lower wall edge;
said lower interior wall and outer perimeter of said bottom exterior surface, when said sampling cassette is placed in said seal and vacuum is supplied to said vacuum connector on said side of said base, whereby air flow into the sample chamber may only occur through said air inlet in said lid when a vacuum means is supplied to a airway on a side of said base, drawing air through said air inlet on said lid into said sample chamber and then out of said sample chamber through said air outlet in said dish and into a airway at said top surface of said base and then through said airway to said vacuum means;
said base employed with a hollow interior within its lower dimension;
said base employed with a tray rotation mechanism for transfer of rotational means to said tray, mounted within said hollow interior;
said tray rotation mechanism having a output shaft extending through a aperture at a top surface of said base, with said output shaft attached to a shaft receptacle, with said shaft receptacle residing within a central aperture in said top surface of said base, with said shaft receptacle form in a complimentary manner to accept and substantially engage with said lower shaft of said capture tray;
said rotation mechanism being attached to a means that allow the operative rotational control of said tray rotation mechanism, said output shaft, said shaft receptacle, said tray shaft, said tray and said capture media, at a predetermined rotational speed;
said base employed with a base cover to cover said hollow interior;
said base employed with sealing means with which to seal said hollow interior cavity from the surrounding environment, in a substantially air tight manner, at all entrance points made from the exterior of said base into said hollow interior for utility, whereby contaminant ingress and egress is restricted.

6. The operative base of claim 2 wherein said seal is composed of materials that allow for complete routine sanitization by chemical or steam sterilization procedures while offering resistance to rapid wear from these procedures, said seal is composed of materials that are of an elastic nature allowing the seal to maintain original structure while being malleable enough to allow a substantially air tight seal between said sampling cassette and said base.

7. The operative base of claim 2 wherein components are constructed from materials which are substantially non-particulate generating and of a substantially non-porous surface finish, whereby complete cleaning and sanitization of component surfaces exposed to the environment can be performed to remove contaminants so as not to jeopardize the environment in which it is utilized.

8. The sampling cassette of claim 1 and operative base of claim 2 wherein the structure of the devices as joined for operation is of a substantially streamline size and shape wherein:
the presence of the joined devices would have minimal disruptive effects on unidirectional or laminar airflow in environments in which it is utilized, whereby the integrity of the environments in which it is utilized will not be jeopardized by its physical presence;
the presence of the joined devices within an environment is not a hindrance to operations performed therein, whereby it may be utilized in a variety of environments;
the presence of the joined devices may be utilized in environments with minimal available work space, whereby its employment may not be limited to environments having only an abundance of available work space.

9. A sampling cassette according to claim 1 wherein said lid is constructed of materials that allows viewing of said tray and said capture media within said sample chamber and which are substantially non-porous and non-particulate generating and would allow for sterilization by chemicals, steam, gamma, or E-beam irradiation, or other applicable means of sterilization.

10. A sampling cassette according to claim 1 wherein said dish is constructed of materials which may be softer than said lid to aid in sealing of said lid to said dish, but of materials which are substantially non-porous and non-particulate generating and would allow for sterilization by chemicals, steam, gamma, or E-beam irradiation, or other applicable means of sterilization.

12. A sampling cassette according to claim 1 wherein said tray is constructed of materials which may would offer ease of rotation within said cylindrical aperture in said dish center, but of materials which are substantially non-porous and non-particulate generating and would allow for sterilization by chemicals, steam, gamma, or E-beam irradiation, or other applicable means of terminal sterilization.

13. A sampling cassette according to claim 1 where said lid may contain more than on air inlet, which are, roughly one half the diameter of said capture media with said sample slit passing transversely through said lid in a radial position to the top center of said lid through to said bottom surface of said lid, opening into said sample chamber, with a air inlet cover arrangement which allows for exposure of only one said air inlet.

14. A sampling cassette to claim 1 where said lid said air inlet(s) may include an inlet formed from a plurality of small geometric apertures aligned in a radial position formed through said top surface of said lid to said bottom surface of said lid.

15. A sampling cassette according to claim 1 wherein said air inlet(s) and said air outlet are covered by adhesive based seals which would disallow the transfer of contaminants into said sample chamber, and are made of materials which are substantially non-porous and non-particulate generating and would allow for sterilization by chemical, steam, gamma, or E-beam irradiation, or other applicable means of sterilization.

16. A sampling cassette according to claim 1 wherein said air inlet(s) and said air outlet are covered by structural covers of plastics, or other material which would disallow the transfer of contaminants into said sample chamber, and are made of materials which are substantially non-porous and non-particulate generating and would allow for sterilization by chemical, steam, gamma, or E-beam irradiation, or other applicable means of sterilization.

17. The sampling cassette of claim 1 wherein said air outlet port is located on the exterior wall of said dish, with a means for attachment to a vacuum source, but substantially in a position below the height the top surface of said capture media upon said tray.

18. The sampling cassette of claim 1 wherein said dish said air outlet port is of any geometric shape, but is maintained at a larger total aperture area than that of said air inlet of said lid.

19. The sampling cassette of claim 1, further including a seal within said sealing channel, locating said seal between said lid and said dish top edge.

20. The combination air sampling cassette and nutrient media plate of claim 1, wherein said air passageway has a substantially uniform width.

21. The sampling cassette of claim 1 wherein said tray may separately support a variety said capture medias, which may be employed during production of said sampling cassette, that would be amenable to a variety analyses; said capture medias may include, but are not limited to, nutrient agars for microbial recovery, absorbent, or adsorbent materials for chemical capture, adhesive materials for spore capture, filter materials for DNA, RNA, viral, microbial, or other viable or non-viable particulate capture, and other materials as suited for specific target material capture.

22. The sampling cassette of claim 1 wherein said media support tray may be replaced with a rotatable filter support platform;
said filter support platform employed with a filter capture media;
said filter support platform including a plurality of spaced radial tines which radiate from a central support structure at the center of said filter support tray to a perimeter ring structure defining the outer margin of said filter support tray;
said filter support platform allowing for a sample air volume to be drawn through said filter capture media, so as to entrain particulate matter with the sampled air volume within the structure of said filter media;
said filter support platform having an upper and a lower support shaft maintaining the top surface of the filter support platform between said dish and said lid, with said upper shaft retained within said cylindrical shaft cup on said interior bottom surface of said lid, with said lower shaft retained in said cylindrical aperture in said bottom surface of said dish, substantially maintaining the filter support platform and a filter capture media at a desired distance from the interior bottom side of said slit inlet in said lid;
said filter capture media may be of a variety of materials, which may be employed during production of said sampling cassette, as defined for specific capture purpose for an intended analysis.

23. The sampling cassette of claim 1 produced and packaged in a sterile manner.

24. The sampling cassette of claim 1 employed with said filter support platform and said filter capture media of claim 22 produced and packaged in a sterile manner.

25. A sampling cassette according to claim 1, in combination with a controller means, said controller means employed for remote operative supply and control of the turntable drive mechanism and vacuum means.
